(19) United States
(12) Patent Application Publication
(10) Pub. No.: US 2018/0124437 A1
(43) Pub. Date: May 3, 2018

(54) SYSTEM AND METHOD FOR VIDEO DATA COLLECTION

(71) Applicant: Twenty Billion Neurons GmbH, Toronto (CA)

(72) Inventors: Roland MEMISEVIC, Toronto (CA); Ingo BAX, Munster (DE)

(21) Appl. No.: 15/608,059

(22) Filed: May 30, 2017

Related U.S. Application Data
(60) Provisional application No. 62/414,949, filed on Oct. 31, 2016.

(51) Int. Cl. H04N 21/234; H04N 21/25; H04N 21/231; H04N 21/2743; H04N 21/854

(52) U.S. Cl. CPC H04N 21/23418; H04N 21/251; H04N 21/854; H04N 21/2743; H04N 21/231

(57) ABSTRACT

A system and method for video data collection from a video provider device. The system comprising: displaying a plurality of label templates on the video provider device; for each label template selected by the video provider: transferring a label-related video file from the provider device to the platform; recording the label-related video file; recording a label text, the label comprising at least a portion of the label template; and associating the label-related video file with the label text. The system comprises a memory for storing video files; and a processor operable to communicate electronically with the memory and the video provider device.

### CROSS-REFERENCE TO RELATED APPLICATIONS

The present patent application claims the benefits of priority of U.S. Patent Application No. 62/414,949, entitled “SYSTEM AND METHOD FOR TRAINING NEURAL NETWORKS FROM VIDEOS”, and filed at the US Patent Office on Oct. 31, 2016, the content of which is incorporated herein by reference.

### FIELD OF THE INVENTION

The present invention generally relates to the collection of video data.

### BACKGROUND OF THE INVENTION

Many intelligent video analysis systems are based on a machine learning model, such as a neural network. To train a neural network to predict a label when given a video as the input, training data in the form of pairs including video and label (video, label) is needed. The number of these pairs has to be large to prevent the machine learning model from overfitting and to facilitate generalization.

The label may be in the form of one of K possible discrete values (this is commonly referred to as “classification”), or in the form of a sequence of multiple such values (this is commonly referred to as “structured prediction” and it subsumes the case that the label is a natural language sentence, which is also known as “video captioning”).

There has been an increasing interest recently in learning more about representations of physical aspects of the world using neural networks. Such representations are sometimes referred to as “intuitive physics” to contrast them with the symbolic/mathematical descriptions of the world developed in physics.

Although images still largely dominate research in visual deep learning, a variety of sizable labeled video datasets has been introduced. A dominating application domain has been action recognition, where the task is to predict a global action label for a given video. A potential drawback of action recognition datasets is that they are targeted at fairly high-level aspects of videos. Typically, a long video sequence is taken as input, producing a relatively small number of global class-labels as output. These datasets require features that can condense a long sequence, often including many scene changes, into a single label.

### SUMMARY OF THE INVENTION

The shortcomings of the prior art are generally mitigated by a system and method for video data collection for machine learning as described herein.

In a first aspect, a system for video data collection from a video provider device is provided. In at least one embodiment, the system comprises a memory for storing video files; and a processor operable to communicate electronically with the memory and the video provider device, the processor operating to: display a plurality of label templates on the video provider device; for each label template selected by the video provider: transfer a label-related video file from the provider device to the processor; record the label-related video file in the memory; record a label text, the label comprising at least a portion of the label template, in the memory; and associate the label-related video file with the label text.

Each label template may comprise at least one placeholder, and for each label template, selected by the video provider, the processor may be operable to: receive a text entry provided by the video provider at the video provider device; and generate the label text based on the label template by replacing the placeholder with the at least one text entry.

Each of the plurality of the label templates may comprise at least one action term. The label text may be the label template.

The memory may further comprise a video database operable to store label-related video files and associated label text.

The at least one text entry may represent an object the action has been applied to.

The processor may be operable to: display a plurality of action groups on the video provider device, each action group having the plurality of label templates; and, for each action group selected by the video provider, the processor may be operable to display the at least one label template.

The processor may be configured to dynamically select the at least one action group to be displayed from an action group database. The processor may be configured to dynamically select the at least one label template to be displayed from a label templates database. The selecting dynamically may be based on collected data related to performance of machine learning models.

The processor may further operate to, upon selection of each label template by provider, display, on the video provider device, a video upload box for that label template for uploading a video file.

The video upload box may allow the provider to play back the label-related video. The video upload box may allow multiple re-uploading of the video.

In at least one embodiment, the system may further comprise an operator device, the processor being further operable to communicate with the operator device. The processor may be further operable to generate and to display, at the operator device, a collection summary comprising a plurality of label texts and a plurality of label-related videos. The collection summary may comprise multiple videos being played and displayed simultaneously on the operator device.

The operator device may be operable to prompt the operator to approve or reject a set of the videos and then to transmit the approval or rejection to the video provider device and to the platform.

The system may be operable to display a feedback text input field at the operator's device, collect the feedback text, transmit the feedback text to the video provider device and display the feedback at the video provider device.

In at least one embodiment, the processor may be further operable to: receive a duration of a grace period for a resubmission of at least one label-related video and a soft-reject message from the operator device, transmit the duration of the grace period and the soft-reject message to the video provider, and, after expiration of the grace period, reject the at least one label-related video.

The memory may comprise a hash-code database, the processor being operable to collect, for each label-related video file, the file hash-code and record the collected hash-code in the hash-code database.

The system may further comprise prompting the video provider to select a batch-size number of label templates to form an assignment.

In at least one embodiment, the processor may be operable to accept an assignment only after all label-related video files of one batch have been uploaded, the batch having the batch-size number of label-related video files, each corresponding to the pre-defined batch-size number of label templates.

The processor may be further operable to evaluate quality of the label-related video file. The memory may comprise a rejects database, the processor being operable to record the collected label-related video file in the rejects database.

The processor may be also operable: to extract a format of the label-related video file; to compare the format of the label-related video file with a permitted format; and if the format of the label-related video file is not in a permitted format, record the label-related video into the rejects database.

The format of the label-related video file may be at least one of file encoding, file extension, video duration.

The processor may be further operable: to extract a format of the label-related video file during uploading of the label-related video-file; to compare the format of the label-related video file with a permitted format during uploading of the label-related video-file; and if the format of the label-related video file is not in the permitted format, send an alert to the video provider device to alert the video provider that the format is not in the permitted format.

The processor may be also operable: to collect a hash code of the label-related video-file while uploading the label-related video-file and, if the video file hash-code is a duplicate of one of the hash-codes stored in the hash-code database, send an alert to the video provider device to alert the video provider that the label-related video-file is a duplicate.

The processor may also operate to: for each newly transferred label-related video file, invoke near-duplicate detection; and if the label-related video file is a near-duplicate of the one of the label-related video file stored in the memory, reject the label-related video file or communicate to the operator device that the uploading of a near-duplicate has been detected.

The processor may operate to analyse data collected in the memory and to generate at least one data subset, the data subset being at least one of training-data subset, validation data subset, or a test-data subset.

The system as described herein may be used for curriculum learning of machine learning models.

The processor may be further operable to, for each label template selected by the video provider: communicate with a video camera to initiate recording; display, on the video provider device, the video being recorded by the video camera and transferring the recorded label-related video file from the provider device to the platform; and communicate with the video camera to stop recording.

The processor may be further operable to record the video and transfer the recorded label-related video file from the provider device to the platform may be done simultaneously.

In a second aspect, there is a method for video data collection from a video provider device by a platform. In at least one embodiment, the method comprises: displaying a plurality of label templates on the video provider device; for each label template selected by the video provider: transferring a label-related video file from the provider device to the platform; recording the label-related video file; recording a label text, the label comprising at least a portion of the label template; associating the label-related video file with the label text.

Each label template may comprises at least one placeholder, and for each label template, selected by the video provider: receiving a text entry provided by the video provider at the video provider device; and generating the label text based on the label template by replacing the placeholder with the at least one text entry. Each of the plurality of the label templates comprises at least one action term. The label text may be the label template.

The at least one text entry may represent an object the action has been applied to. The at least one object text may represent an object the action has been applied to.

The method may further comprise: displaying a plurality of action groups on the video provider device, each action group having the plurality of label templates; and, for each action group selected by the video provider, displaying the at least one label template. The method may further comprise dynamically selecting the at least one action group to be displayed from an action group database. The method may further comprise dynamically selecting the at least one label templates to be displayed from a label templates database. The selecting dynamically may be based on a collected data related to performance of machine learning models.

The method may further comprise, upon selection of each label template by provider, displaying, on the video provider device, a video upload box for that label template for uploading a video file.

The method may further comprise generating and displaying, at an operator device, a collection summary comprising a plurality of label texts and a plurality of label-related videos. The collection summary may comprise multiple videos being played and displayed simultaneously on the operator device.

The method may further comprise prompting the operator to approve or reject a set of the videos and then transmitting the approval or rejection to the video provider device and to the platform.

The method may further comprise displaying a feedback text input field at the operator's device, collecting the feedback text, transmitting the feedback text to the video provider device and displaying the feedback at the video provider device.

The method may further comprise: receiving a duration of a grace period for a resubmission of the label-related video and a soft-reject message from the operator device, transmitting the duration of the grace period and the soft-reject message to the video provider, and, after expiration of the grace period, rejecting the label-related video.

The method may further comprise collecting, for each label-related video file, the file hash-code and recording the collected hash-code in a hash-code database.

The method may further comprise: for each newly transferred label-related video file, extracting a video file hash-code and comparing the video file hash-code with the hash-codes stored in the hash-code database; and if the video file hash-code is a duplicate of one of the hash-codes stored in the hash-code database, rejecting the label-related video file.

The method may further comprise: for each newly transferred label-related video file, invoking near-duplicate detection; and if the label-related video file is a near-duplicate of the one of the label-related video file stored in the memory, rejecting the label-related video file or communicating to the operator device that the uploading of a near-duplicate has been detected.

The method may further comprise prompting the video provider to select a pre-defined batch number of label templates.

The method may further comprise accepting an assignment only after all label-related video files of one batch have been uploaded, the batch having a pre-defined batch number of label-related video files, each corresponding to the pre-defined batch number of label templates.

The video upload box may allow the provider to play back the label-related video. The video upload box may allow multiple re-uploading of the video.

The method may further comprise evaluating quality of the label-related video file. The method may further comprise recording the collected label-related video files in a rejects database.

The method may further comprise extracting a format of the label-related video file; comparing the format of the label-related video file with the pre-defined system format; and if the format of the label-related video file is not in a pre-defined system format, recording the label-related video into the rejects database.

The format of the label-related video file may be at least one of file encoding, file extension, video duration.

The method may further comprise: extracting a format of the label-related video file during uploading of the label-related video-file; comparing the format of the label-related video file with a pre-defined system format during uploading of the label-related video-file; and if the format of the label-related video file is not in the pre-defined system format, sending an alert to the video provider device to alert the video provider that the format is not in the pre-defined system format.

The method may further comprise: collecting a hash code of the label-related video-file while uploading the label-related video-file and, if the video file hash-code is a duplicate of one of the hash-codes stored in the hash-code database, sending an alert to the video provider device to alert the video provider that the label-related video-file is a duplicate.

The method may further comprise analysing data collected in the memory and generating at least one data subset, the data subset being at least one of training-data subset, validation data subset, or a test-data subset.

The method as described herein may be used for curriculum learning of machine learning models.

The method may further comprise, for each label template selected by the video provider: communicating with a video camera to initiate recording; displaying, on the video provider device, the video being recorded by the video camera and transferring the recorded label-related video file from the provider device to the platform; and communicating with the video camera to stop recording. Recording the video and transferring the recorded label-related video file from the provider device to the platform may be done simultaneously. An example video demonstrating the action to be performed may be displayed near the video upload box.

Other and further aspects and advantages of the present invention will be obvious upon an understanding of the illustrative embodiments about to be described or will be indicated in the appended claims, and various advantages not referred to herein will occur to one skilled in the art upon employment of the invention in practice.

### BRIEF DESCRIPTION OF THE DRAWINGS

The above and other aspects, features and advantages of the invention will become more readily apparent from the following description, reference being made to the accompanying drawings in which:

FIG. 1 is a schematic diagram of components interacting in a system for video data collection, in accordance with at least one embodiment;

FIG. 2 is a screenshot of an example video provider interface, in accordance with at least one embodiment;

FIG. 3 is a screenshot of an example video provider interface, in accordance with at least one embodiment;

FIG. 4 is a screenshot of an example video provider interface, in accordance with at least one embodiment;

FIG. 5 is a screenshot of an example video provider interface, in accordance with at least one embodiment;

FIG. 6 is a screenshot of an example video operator interface, in accordance with at least one embodiment;

FIG. 7 is a screenshot of an example video provider interface, in accordance with at least one embodiment;

FIG. 8 is a screenshot of an example operator interface, in accordance with at least one embodiment;

FIG. 9 is a screenshot of an example operator interface, in accordance with at least one embodiment;

FIG. 10 is an example screenshot of a set of demonstration videos along with corresponding labels and descriptions as seen by an operator;

FIG. 11 shows examples of screenshots of videos for different labels, in accordance with at least one embodiment;

FIG. 12 shows a block diagram of the method, in accordance with at least one embodiment;

FIG. 13 shows an example of workflow for a crowdworker, in accordance with at least one embodiment;

FIG. 15 shows an example of workflow for the operator, in accordance with at least one embodiment;

FIG. 16 shows an example of a screenshot with different messages, in accordance with at least one embodiment;

FIG. 17 shows an example screenshot with a submission as seen by an operator, as well as a reject-button, a soft reject-button and an approve-button;

FIG. 18 shows an example of a screenshot with an approval message, in accordance with at least one embodiment;

FIG. 19 shows an example of a screenshot with a rejection message, in accordance with at least one embodiment;

FIG. 20 shows an example of a screenshot with a soft rejection message, in accordance with at least one embodiment;

FIG. 21 shows an example of a screenshot with an overview of video collection tasks, in accordance with at least one embodiment;

FIG. 22 shows an example of a screenshot with an overview of video providers along with statistics about the providers and the tasks they have accepted or submitted, in accordance with at least one embodiment;

FIG. 23 shows an example of a screenshot with a search though submitted videos by label, in accordance with at least one embodiment;

FIG. 24 shows an example of a screenshot with a search though submitted videos by label, in accordance with at least one embodiment; and

FIG. 25 shows an example screenshot of video-labeling task, in accordance with at least one embodiment.

### DETAILED DESCRIPTION OF A PREFERRED EMBODIMENT

A novel system and method for video collection will be described hereinafter. Although the invention is described in terms of specific illustrative embodiments, it is to be understood that the embodiments described herein are by way of example only and that the scope of the invention is not intended to be limited thereby.

The data collected with this invention may help to train discriminative machine learning models, which may take a video as input and generate a label, as defined below, as output. The models are typically defined as neural networks. More specifically, they usually contain so-called convolutional layers (even more specifically, they may contain 2d-convolutional layers, 3d-convolutional layers, or combinations of these). In some cases, they may also contain recurrent layers, such that the overall model is a recurrent neural network. The models may be trained by using gradient-based optimization to minimize a cost function that quantifies how close the network output is to the desired output. The desired output is determined by the labels.

By design, the videos collected with this platform may differ from videos collected by other means, such as randomly chosing videos from the internet, in that they may contain actions and motion patterns that are highly application-relevant. This may make these videos more suitable for unsupervised learning as well.

In at least one embodiment, the systems and methods as described herein may be implemented as a non-transitory computer-readable storage medium configured with a computer program, wherein the storage medium so configured causes a computer to operate in a specific and predefined manner to perform at least some of the functions as described herein.

The system and the method described herein facilitate generation and collection of training video data.

The pre-dominant way of creating large, labeled datasets for training machine learning models is by starting with a large collection of input items, such as images or videos. Usually, these are found using online resources, such as Google image search or Youtube. Subsequently, the gathered input examples are labeled by human workers. Since the number of labels may be very large, it is common to use crowdworkers from services like Amazon Mechanical Turk (AMT) or Crowdflower to perform labeling.

The system and method described herein prompt the human workers to provide input items (such as videos) rather than annotating (such as providing labels for) given input items. This may address the problem that the videos required to train systems for common video use cases cannot be easily found online. Most readily available videos are typically long and contain many scene changes.

The system and method described herein may facilitate the collection of videos by making it possible to orchestrate and scale the video collection. For example, such system and method may be used to collect videos at a rate of thousands of videos per day and at a cost of less than 10 cents (USD) per video thus providing for, for example, collecting of 250 000 videos within about 6 months.

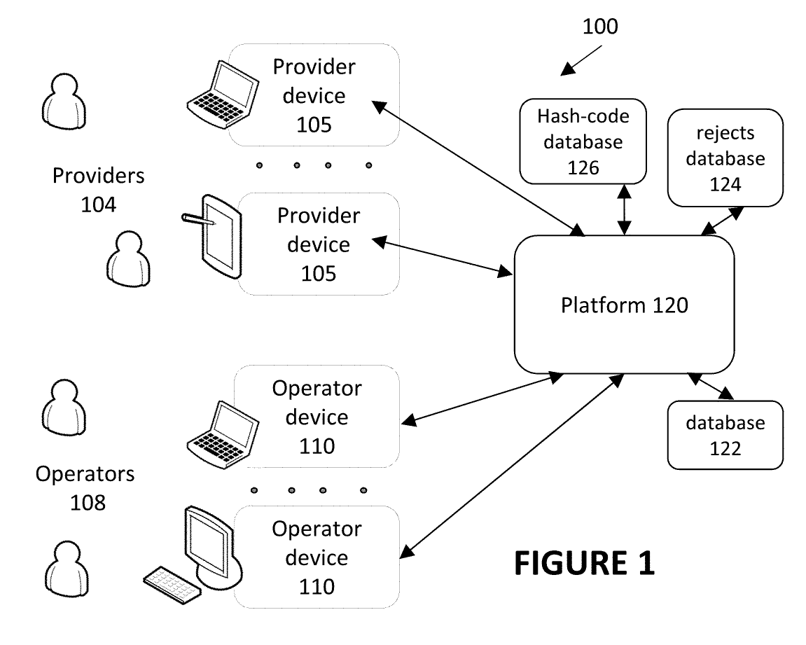

Referring now to FIG. 1, the system 100 for video data collection comprises a memory for storing video files and a processor operable to communicate electronically with the memory. For example, the processor may be a platform 120. The system may further include video provider devices 105 and operator devices 110 with which the processor is operable to communicate electronically.

In at least one embodiment, the platform 120 may be a non-transitory computer-readable medium, comprising instructions stored thereon, that when executed on a processor, perform the steps as described herein.

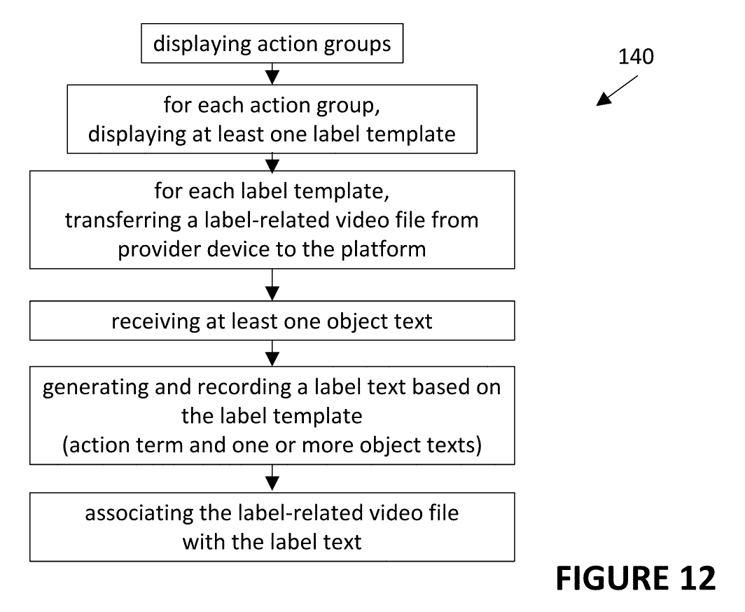

Referring now to FIG. 12, shown therein is a method 140 for video data collection. First, a plurality of action groups is displayed on the video provider device 105. Each action group may correspond to one or more label templates. For each action group selected by the video provider, at least one label template is displayed. The at least one label template may have an action term and may have one or more placeholders. For example, the label template may have zero, one or several placeholders. For example, the label may be “sit down”, or “jump”, or “make this or that gesture”. The processor may dynamically select the at least one label template to be displayed from a dictionary or a label templates database.

Further, for each label template selected by the video provider, the system transfers (uploads) a label-related video file from the provider device and records that label-related video file. The system then receives at least one object text provided by the video provider. Based on the label template, action term, and the at least one object text, a label text (or “label”) is generated and recorded. Such generated label text is then associated with the label-related video file uploaded.

Referring again to FIG. 1, the video providers (hereafter “providers”) 104 may be, for example, workers which may include company personnel and crowdworkers who may provide their services through a crowdsourcing service, such as, for example, Amazon Mechanical Turk (AMT). The providers 104 may connect to the platform 120 to receive instructions and subsequently upload videos in accordance with those instructions.

Operators 108 (who may be typically company personnel, but may also be crowdworkers) may connect to the same platform 120 to oversee the data collection campaign. This may involve reviewing and approving or rejecting the videos uploaded by the video providers, communicating with the video providers and defining or modifying the definition of labels.

The video providers' devices 105, the operators' devices 110, and the platform 120 may have a processor, a memory, and display and may be an electronic tablet device, a personal computer, workstation, server, portable computer, mobile device, personal digital assistant, laptop, smart phone or any combination of these.

For example, videos collected with the platform 120 may be typically between 1 and 6 seconds in duration. The videos that may be crowd-acted with the platform span a variety of use cases, including, for example, human gestures (for automatic gesture recognition) and/or aggressive behavior (for video surveillance). Unlike gathering videos online, the use of video collection as described herein may also make possible to generate video data for training generic visual feature extractors, which may be applicable across multiple different use-cases.

In at least one embodiment, providers 104 may sign on to the platform 120 to provide videos, and the operators 108 may sign on to oversee the data collection operation. For example, instructions about the video recording task may be provided on the crowdsourcing site, and providers 104 may be forwarded to the platform 120 upon accepting the task (for example, the provider may be prompted to follow the link to the platform 120).

The platform 120 may then communicate with the crowdsourcing service to submit the status (accept/reject) of the task upon completion, and to issue payments, etc.

For example, to ensure high responsiveness in face of bandwidth and processing requirements imposed by the usually high-bandwidth video data, the platform 120 may run in the cloud (such as for example Amazon web services) and elastic load balancing may be used to distribute the workload across dedicated computer servers.

An interactive web-platform for video data collection is described herein. The platform 120 may mediate between video providers 104 and operators 108 in an ongoing video collection campaign. To video providers 104, the platform 120 may provide tools and facilities for uploading and organizing videos. To operators 108, the platform may provide tools and facilities for reviewing and approving or rejecting videos, for communicating with video providers 104, and for organizing, managing and overseeing video data collection campaigns.

The system and method as described herein may use action groups and contrastive examples, to ensure that video data is suitable for training machine learning models with minimal overfitting (making model too complex).

Label templates (e.g. “Dropping [something] onto [something]”) may be used to sample the otherwise large space of (action/object)-combinations. Label templates may exploit the fact that (action/object)-combinations are highly unevenly distributed. They may make it possible for video providers 104 to choose themselves appropriate objects in response to a given action template.

Through the use of label templates (previous point), the platform may also facilitate curriculum learning. Since label template may interpolate between simple one-of-K labels and full-fledged video captions (textual descriptions), they may make it possible to collect videos incrementally and with increasing complexity. The degree of complexity of the labels may be a function of the performance of machine learning models on the data collected so far.

An interface may allow label templates to be completed conveniently by replacing placeholders with an input field (input mask) once a video has been uploaded.

A video reviewing interface for operators 108 may allow operators 108 to play multiple videos at the same time, making it possible to gain an overview of the quality of the (multivideo) while overviewing one assignment or a set of assignments at a single glance. The video inspection view for operators 108 may also allow searching through the uploaded videos or inspecting videos from a single provider. It may be possible to track, and, if applicable, to react to, similarities of the video that may be harmful to the machine learning models, i.e. which affect the ability of machine learning models to generalize.

The operator may play multiple videos at the same time by clicking the “play”-button for multiple videos. The platform may also provide a “play all”-button allowing the operator to initiate playback of all displayed videos at the same time.

The system may further provide persistent uploading sessions. Video providers 104 may create a job by choosing a set of video templates. They may then, in a time-frame spanning at least several days, incrementally provide videos. Such batching of video submissions (technically realized by releasing a submit button only upon completion of a full batch) may allow reducing overhead for the provider and thereby cost. Secondly, the system may keep track of data provided by each video provider 104, allowing for provider-specific issuance of tasks and/or for quality control by operators.

Videos may be first stored locally by the providers before being uploaded to the system 100. Sometimes videos may be stored on additional local devices, such as, for example, a cell-phone. The videos may also be cut or otherwise preprocessed by the providers before being submitted. Batching may give the provider an interface and opportunity to arrange/modify/update and tweak their video submission until they deem it as suitable for submission.

Each video may be stored in the (central) video database 122 immediately upon passing the automatic quality control checks. This may be necessary because the backend that serves the platform may be distributed across multiple servers, and not on the local storage. Once a submission is completed and verified, so that the submit-button is released, and the provider clicks it, the submission may be reviewed by an operator. When the operator approves the submission, the at that point already saved videos in the database 122 may be “flagged” as approved or rejected (by generating an appropriate entry in a database, which indexes all videos ever uploaded).

The system and method may further provide on-the-fly quality inspection of uploaded videos and provided placeholder-entries (also referred to herein as “input text”, “object text”).

The system 100 may activate and/or de-activate label templates for incremental dataset collection, allowing to “steer” data collection in response to performance of machine learning models trained on the data collected so far. The system 100 may also follow an algorithm for the automatic optimization of data set partitioning into train subset, validation subset, and test subsets.

The system 100 and method as described herein may be applied to crowdsourcing of videos for generic video feature learning. Generic video features may be used for transfer learning and they may require a high degree of variability, which only human-generated videos may provide.

Referring again to FIG. 1, in at least one embodiment, the platform 120 may send instructions to the providers 104 to film themselves performing short actions on one or more objects according to predefined, templated descriptions. For example, a list of possible descriptions may be pre-defined so as to provide a comprehensive set of visual and physical concepts and to provide the fine-grained distinctions that may force neural network models trained on this data to develop a deep understanding of the underlying physical concepts. Since videos are conditioned on descriptions, no separate labeling stage may be required. In at least one embodiment, additional labels and question/answer-pairs may be added to some videos to improve coverage of available descriptions and to explore a question-answering paradigm in the context of videos.

After the provider 104 has signed in for a task (or after having been redirected from a crowsourcing service), and after the provider 104 has accepted the terms and conditions, the platform 120 may present a list of action groups to the provider 104.

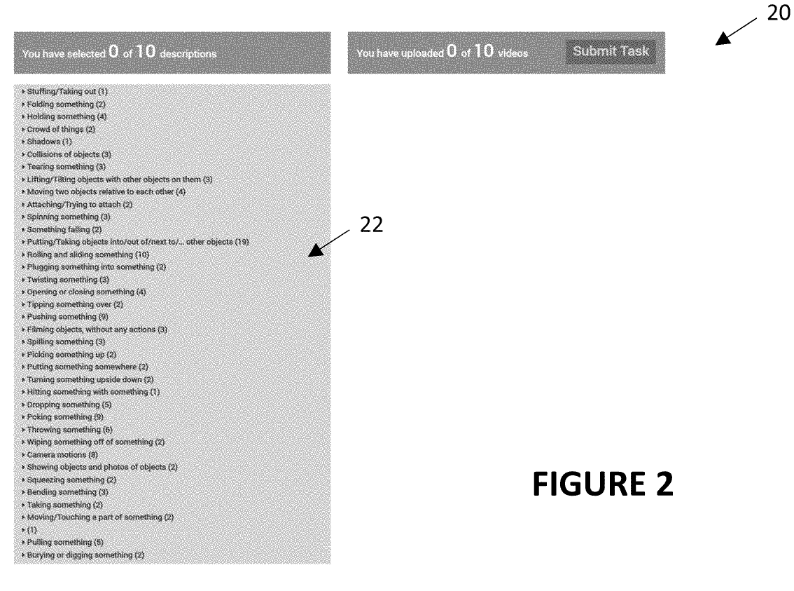

FIG. 2 shows a screenshot 20 of the screen displayed by the system 100 to the provider 104 when the assignment has not been completed yet (so-called “empty assignment”). An exemplary list of action groups 22 may be shown at such screen display.

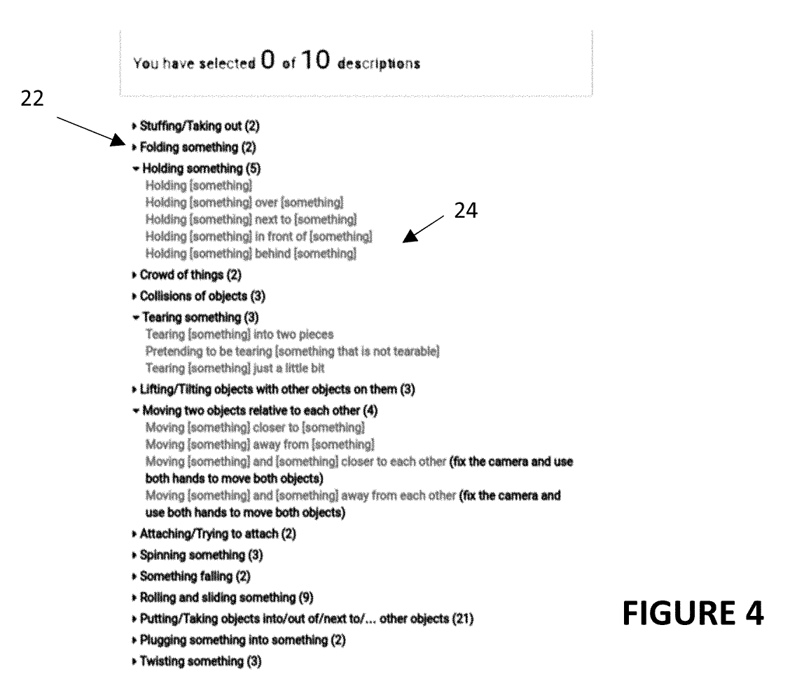

As described herein, the action groups 22 may need to be suitable for machine learning. For example, the action groups may be: “Stuffing/Taking out”, “Folding something”, “Holding something”, “crowd of things”, “Collisions of objects”, “Tearing something”, “Lifting/Tilting objects with other objects on them”, “Spinning something”, “Moving two objects relative to each other”, etc. (see FIG. 4 for further examples of action groups 22). The action term in these action groups may be, for example: “Stuffing/Taking out”, “Folding”, “Holding”, “Crowd of”, “Collisions of”, “Tearing”, “Lifting/Tilting with other”, “Spinning”, “Moving . . . relative to each other”, etc.

Alternatively, the providers may be prompted to record videos “on-the-fly”, as described below. In this case, the platform may show example videos and a countdown, so that providers may film themselves (possibly using multiple trials).

A machine learning model trained on videos may learn to overfit on a given task by representing labels using tangential aspects of the input videos that do not really correspond to the meaning of the label at hand. A model may learn to predict the label “dropping [something]”, for example, as a function of whether a hand is visible in the top of the frames, in case the videos corresponding to other labels do not share this property.

A contrastive example (or “contrastive class”) may be an action which is very similar to a given action to be learned by the model, but which may contain one or several, potentially subtle, visual differences to that class, forcing the model to learn the true meaning of the action instead of tangential aspects. Examples may be the “pretending”-classes. For example, a neural network model may learn to represent the “picking-up” action using the characteristic hand-motion of that action. The class “Pretending to pick up” may contain the same hand-motion, and may just differ from the original class in that the object does not move. That way, the contrastive class “Pretending to pick up” may force a neural network to capture the true meaning of the action “Picking up”, preventing it from wrongly associating the mere hand-motion as the true information-carrying aspect of that class. Geometrically, contrastive examples may be training examples that are close to the examples from the underlying class to be learned (like “Picking up”). Since they belong to a different class (here “Pretending to pick up”) they may force neural network models trained on the data to learn sharper decision boundaries.

Technically, contrastive classes may simply form an action group together with the underlying action class to which they provide contrast.

In order to prevent a machine learning model from overfitting and forcing networks to develop a fine-grained understanding of the true underlying visual concepts, the platform 120 may allow grouping of labels into action groups 22.

Action groups 22 may be designed such that a fine-grained understanding of the activity may be required in order to distinguish the actions within a group. Action groups 22 may also force video providers 104 to focus on the fine-grained and possibly subtle distinctions that uploaded videos need to satisfy in order to constitute high-quality data for training models.

Another benefit of using action groups 22 is that they may help efficiency of providers (e.g. crowdworkers) by allowing them to quickly perform and record multiple similar actions with the same object.

An important type of action group 22 may be obtained by combining an action type with a pretending-action, where the video provider may be prompted to pretend to perform an action without actually performing it.

For example, an action group 22 may consist of the actions “Picking up an object” and “Pretending to pick up an object (without actually picking it up)”. Action groups may force neural networks trained on the data to closely observe the object instead of secondary cues such as hand positions. They may also force networks to learn and represent indirect visual cues, such as whether an object is present or not present in a particular region in the image.

Other examples of action groups 22 may be: “Putting something behind something/Pretending to put something behind something (but not actually leaving it there)”; “Putting something on top of something/Putting something next to something/Putting something behind something”; “Poking something so lightly that it does not or almost does not move/Poking something so it slightly moves/Poking something so that it falls over/Pretending to poke something”; “Pushing something to the left/turning the camera right while filming something”; “Pushing something to the right/turning the camera left while filming something”; “Pushing something so that it falls off the table/Pushing something so that it almost falls off the table”.

In at least one embodiment, the platform 120 may permit a configuration where the provider 104 may be prompted to select all label templates 24 (actions) within a group of actions 22.

In at least one embodiment, the platform 120 may prompt and allow the provider 104 to choose freely from the label templates 24 (list of actions) within one or more groups of actions 22. Even in the latter case, label templates 24 may still be grouped. The grouping of the actions may yield higher quality submissions. For example, grouping may communicate to the video provider 104 the purpose and role of their submissions, and the types of fine-grained distinctions the platform 120 would like to collect and store in different videos.

The system 100 as described herein may address a variety of technical challenges related to collecting video data, which are not currently addressed by existing crowdsourcing services.

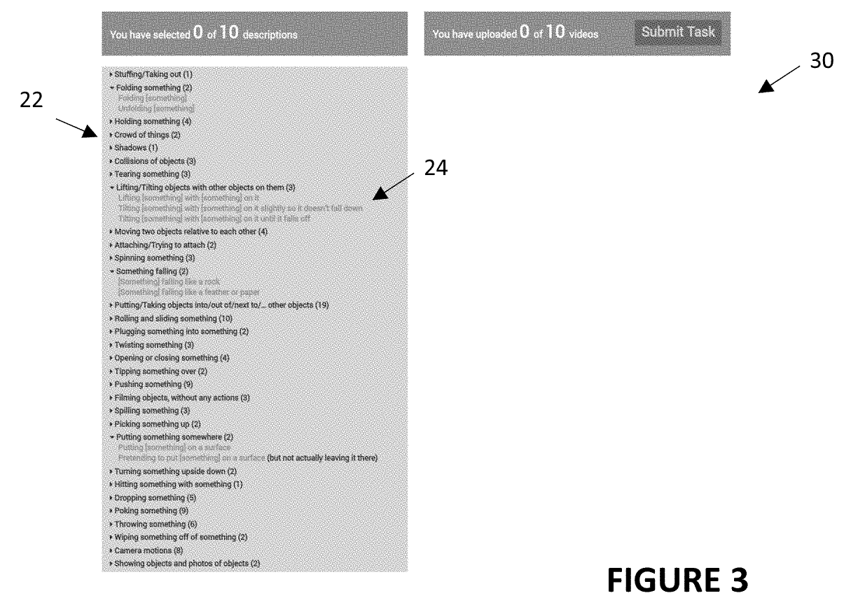

FIG. 3 shows another example of the screen displayed (screenshot) to the provider 104 when some action groups 22 are expanded when the assignment is still empty. For example, each action group 22 of the list may contain one or more label templates 24 that are displayed by the system 100 (becomes visible) when the provider 104 clicks on a specific action group 22.

Label templates 24 represent actions to be acted out by the provider 104. In at least one embodiment, the label templates 24 may contain one or multiple placeholders, typically representing objects, which more closely characterize one action.

FIG. 4 shows an enlarged view of the exemplary list of action groups 22 with expanded label templates 24. For example, the label templates 24 may be: “Dropping [something]”, “Jumping over [something]”, “Hiding [something] behind [something]”. The placeholders here are “[something]”.

In image recognition systems and datasets, labels typically take the form of a one-of-K encoding, such that a given input image is assigned to one of K labels. In currently existing video recognition datasets the labels typically correspond to actions. However, most actions in a video typically involve one or more objects, and the roles of actions and objects may be naturally intertwined. As a result, the task of predicting or of acting out an action verb may be closely related to the task of predicting or acting out the involved objects.

For example, the phrase “opening NOUN” may have drastically different visual appearances, depending on whether “NOUN” in this phrase is replaced by “door”, “zipper”, “blinds”, “bag”, or “mouth”. There may be also commonalities between these instances of “opening”, like the fact that parts are moved to the sides giving way to what is behind. It is, of course, exactly these commonalities which may define the concept of “opening”. Therefore, understanding of the underlying meaning of the action word “opening” depends on the ability to generalize across these different use cases.

What may make collection of video data in terms of actions and objects challenging is that Cartesian product of actions and objects constitutes a space that is so large, that it may be hard to sample it sufficiently densely as needed for most practical applications. However, the probability density of real-world cases in the space of permissible actions and objects is far from uniform.

For example, many actions, such as “Moving an elephant on the table” or “Pouring paper from a cup”, for example, may have almost zero density. And the combinations that are more reasonable can nevertheless have highly variable probabilities. Consider, for example, “drinking from a plastic bag” (highly rare) vs. “dropping a piece of paper” (highly common).

In order to obtain samples from the Cartesian product of actions and objects, it may be possible to exploit the resulting highly non-uniform (equivalently, low entropy) distribution over actions and objects. To do so, the platform 120 may use the following sampling scheme as described herein.

Each video provider 104 may be presented with an action in the form of a template that may contain one or several placeholders for objects. The video provider 104 may then decide which objects to perform the action on and record a video clip. When uploading the video, video providers 104 may be prompted to enter their object choice(s) into a provided input mask.

In at least one embodiment the platform 120 may use placeholders for other parts-of-speech, such as adjectives, adverbs, conjunctions, numerals, etc.

The use of label templates may be viewed as approximations to full natural language descriptions and they may dynamically increase in complexity in response to the learning success of machine learning models. For example, by incrementally introducing parts of speech, such as adjectives or adverbs. For example, this may make it possible to generate output phrases whose complexity may vary from very simple (“pushing a pencil”) to very complex (“pulling a blue pencil on the table so hard that it falls down”).

Slowly increasing the complexity of the data used to train a machine learning model is known as “curriculum learning”.

The label templates 24 may be generated by the system or may be pre-defined and stored in the database 122.

Label templates presented to the video providers may contain additional explanatory text that explains and clarifies what is meant by the label templates. For example, the label template (including explanatory text in parenthesis) may be: “Pouring [something] into [something] (point the camera at the object you're pouring into)” or “Moving [something] and [something] closer to each other (fix the camera and use both hands to move both objects)”.

The list of label templates 24 to choose from may be larger than the number of videos that the provider 104 may be asked to actually upload. The reason is that some actions may not be easily performed by a given provider 104. For example, a set of objects required for a particular action may not be available to one particular provider 104, or the provider 104 may not have the skills required to perform a particular action displayed by the system 100.

For example, the number of requested videos (batch size, Nbatchsize) may be pre-defined. For example, the batch size Nbatehsize may be set by the system operator. For example, the provider 104 may be asked to provide 10 videos i.e. the batch size Nbatchsize may be set to 10.

The task of recording a batch of the batch size Nbatchsize videos (a batch-size number of videos) will be referred to herein as one assignment.

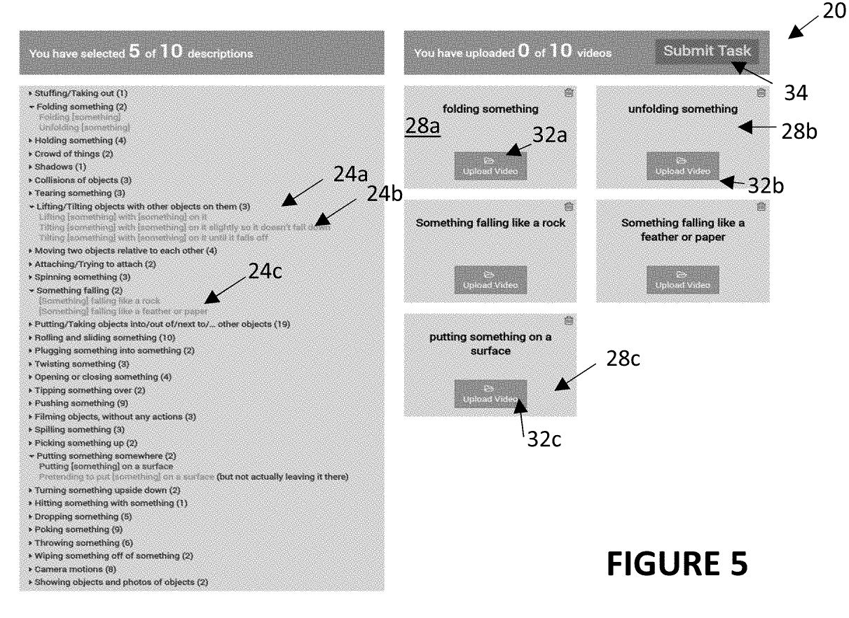

Referring now to FIG. 5, upon selection of (clicking on or in the vicinity of) one of the label templates 24a, a video upload box 28a for this label template 24a may be generated. The upload box 28a may contain a button 32a that, when activated by a click received from the provider 104, may start uploading a provider's video for this label template 24a (see FIG. 5). Similarly, upon a click received from the provider 104 on other label templates 24b, 24c, a video upload box 28b, 28c for these label templates 24b, 24c may be generated. Such video upload box 28b, 28c each may contain an upload button 32b, 32c. The upload button 32b, 32c may allow the video provider 104 to upload a corresponding video for these label templates 24b, 24c. The video upload box may allow multiple re-uploading of the video as often as required until the provider deems the video being appropriate to satisfy the requirements.

The system 100 may further comprise a database 122. The database 122 may be a memory adapted to store data. For example, the platform 120 may comprise the database 122.

After the video (also referred herein as “label-related video file”) is uploaded, the system 100 may record it in the database 122.

For example, the system 100 may convert the video into the pre-defined format. The system 100 may provide a feedback to the provider 104 regarding the format of the video as described herein.

The system 100 may then display a video playback box 33 for each video uploaded by the provider 104. Each uploaded video may be displayed by the platform 100 in a video playback box 33. For example, the uploaded video may be displayed as a screenshot showing a single frame from the video. The uploaded video may be played back, for example, upon clicking on the screenshot. The operator 108 or the video provider 104 may inspect the uploaded video and the uploaded video may also be replaced by a different video, if desired. For example, the video provider may click the upload button again to upload the different video, in which case the old video will be overwritten.

After uploading a video, any placeholders in the corresponding label template 22 (usually represented by the word “something”), may turn automatically into input masks, and the video provider 104 may be prompted to fill in at least one input text (appropriate expression such as the noun-phrase describing the object used in the video) in place of the at least one input mask corresponding to the label template. For example, the platform 120 may find text-parts enclosed in square brackets within the label-template-string. For each of these, it may generate an HTML input element of type text. It may then display the label including these input-elements in the interface so that the provider may complete the phrase.

For example, if the video provider 104 selected the template “Dropping [something] onto [something]”, the two placeholders and then input masks would be “something” and “something”. For an uploaded video showing a person dropping a pen onto a table, the input texts to be entered in the two input masks shown in the upload box would be “pen” and “table”.

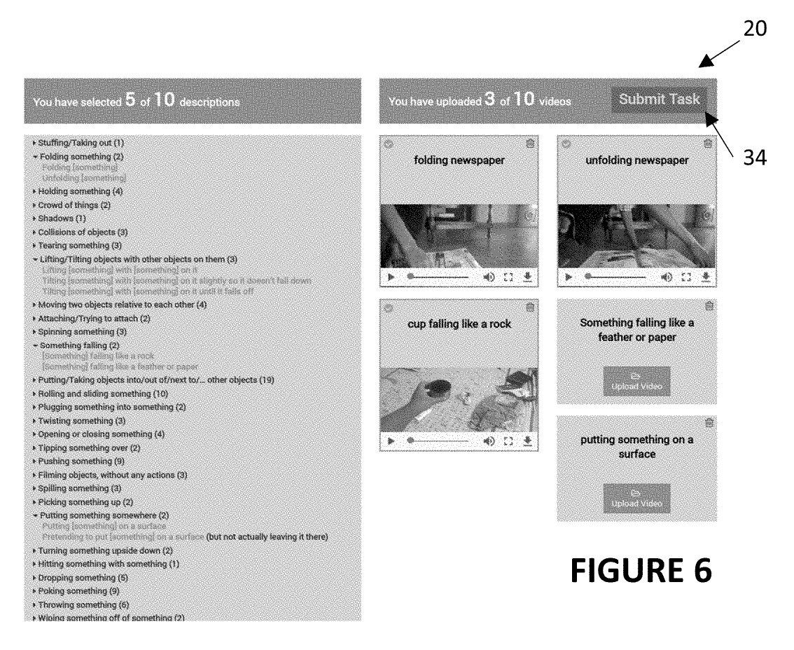

FIG. 6 shows an exemplary screenshot with a completed assignment.

After the video provider 104 has uploaded a requested number (Nbatchsize) of videos (batch-size number of videos), a submission button 34 (for example, entitled “Submit Hit”) may get released by the platform 120. The released submission button 34. This may allow the video provider 104 to submit the whole batch of videos.

One motivation for batching submissions is that recording, potentially preparing, and uploading a video, may generate overhead on the side of the video provider. For example, the overhead may include steps the provider would have to take to record, potentially preprocess and upload a video, including preparing a workspace, saving videos temporarily, potentially cutting videos, and clicking the appropriate buttons to upload it. Batching may help to minimize the overhead, and thereby reduce the cost per video, by allowing video providers 104 to initiate a submission and come back to it later, potentially multiple times until the submission is completed.

Besides reducing overhead, batching may also allow video providers 104, depending on the requirements imposed by the label templates 24, to record videos outside or at other places or times of the day, or after having gathered the tools or objects that the activity to be acted may require. This may require an uploading interface that supports persistent uploading sessions. Persistent uploading sessions are currently not supported by existing crowdsourcing services and platforms, such as, for example, Amazon Mechanical Turk.

The platform may make it possible for video providers to record videos on-the-fly, that is, during the process of interacting with the platform, using a camera (such as a webcam) that is attached to the device with which the video providers interact with the platform. To this end, the platform may display a video-upload-box that continuously shows the current camera-input (Figure). When recording videos on-the-fly, the platform may prompt the provider to act out the label to be recorded. It may use a countdown to indicate to the provider when recording will start (Figure).

The platform may show demonstration videos, provided either by operators, or drawn from videos recorded previously by other providers, next to the video recording-box.

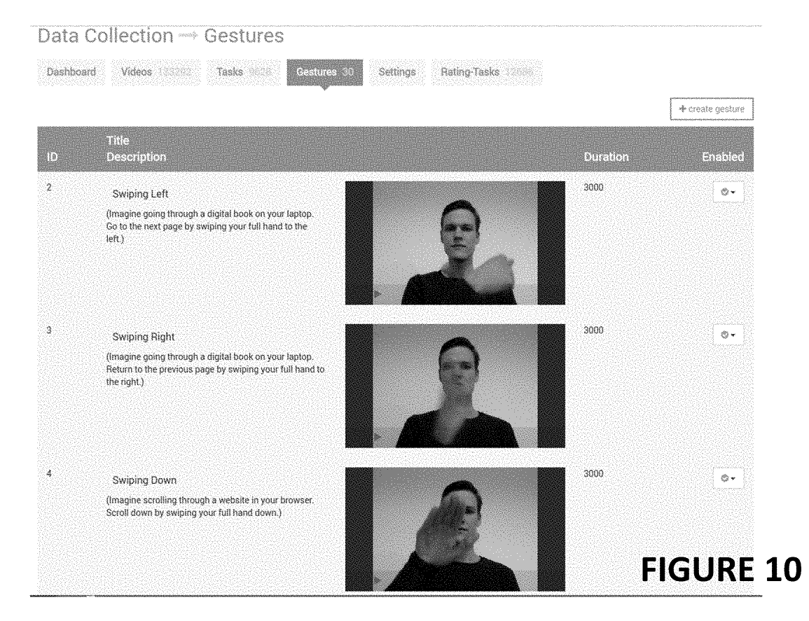

Referring now to FIG. 10, the platform may provide an interface that allows operators to create labels and upload corresponding demonstration videos.

The platform may allow the provider to go through a “dry” run to practice the recording before performing the actual recording.

The platform may allow the provider to play back, as well as to overwrite any given recording in the batch one or multiple times before submitting the batch.

The platform may allow recording of videos interactively, that is, by providing feedback during recording. That way, the platform may allow the collection of videos with finely structured labels that are synchronised with the video. For example, the platform may ask providers to follow an indicator (such as a dot shown on the screen) with their hand to collect data consisting of trajectories (labelled frame-by-frame) of finger-pointing positions. Another example is the collection of label-sequences that describe human poses. Another example is the collection of gesture sequences, such that labels may be sequences of gestures that are synchronized with the video.

Label templates with placeholders to be filled by the video-provider may also be used in the on-the-fly-recording operation.

Since uploading batches of multiple video files may require a significant amount of work by the video provider 104, the system 100 may inspect every uploaded video on-the-fly by automatic quality control mechanisms. The system 100 may reject on-the-fly the individual video that does not satisfy the automatic quality control inspection without affecting the other videos of the batch.

In at least one embodiment, the system 100 may block the submission of the batch (for example, by a non-active “submit”-button) until each of the uploaded videos of the batch satisfy all the automatically verifiable acceptance criteria. The uploaded videos of the batch may be stored in the permanent storage and may be “flagged” as being approved or rejected after they pass the automatic quality control (e.g. immediately after passing the inspection) and therefore the provider does not need to re-upload the approved videos another time in order to complete the submission of the batch. Rejecting or approving a whole batch because of a subset of videos that does not satisfy the requirements (and therefore demanding the provider to re-upload the whole batch another time), would waste time of the video provider and result in a higher-than-necessary cost per video.

Through the choice of Nbatchsize, batching may also provide a means of influencing the crowdsourcing-inflow (the rate at which providers 104 sign up for the required task) and thereby the cost of the operation of uploading video files. For example, Nbatchsize may be set by trial-and-error, and/or it may be optimized automatically (using stochastic optimization) so as to optimize inflow of the video files.

In at least one embodiment, the system 100 may collect data on the quality of the video provided by the video providers 104. For example, the providers 104 who reliably and persistently create high quality submissions may be assigned to a set of pre-approved providers, whose submissions are accepted automatically. These, as well as all other submissions, may go through quality control checks that may be performed by the system 100 immediately upon submission of the video files by the provider 104. The quality of the label-related video file may be evaluated.

The quality control checks may be performed on the server (of which there may be multiple instances for scalability) serving the interface to the operator. Since this server cannot provide permanent storage (different servers may correspond to different videos or types of videos, and they may be spawned and shut down by demand), an approved video may be transferred to the permanent storage of database 122 immediately upon passing the quality control checks.

In at least one embodiment, the system 100 may verify the encoding and format of the video. For video files to be suitable for training machine learning models, they have to adhere to an agreed-upon formatting and encoding standard that model developers use for training. To avoid wasted recording efforts on the side of the video provider 104 (and, thus, reduce cost), transforming (recoding) to the agreed-on format and standard is attempted for each video immediately upon uploading.

The recoding may be done, for example, as follows. In at least one embodiment, the system 100 may store the video in the original format (as sent by the provider) in a temporary storage, and may (e.g. immediately) recode that video-file to the target format. At this point, quality control checks (see below) may also be performed (including checking duration, orientation, etc). If recoding succeeds and the checks pass, then the original video and the recoded version may be transferred to the central (permanent) storage of database 122. The temporary storage and operations may be performed on multiple hosts serving the platform, while the permanent storage of database 122 may be a central, shared resource.

If the system fails to recode the video to the target encoding, then such failure message may be communicated (e.g. immediately) to the video provider 104. The platform 120 may prompt the video provider 104 to change, for example, the local video formatting or a camera device (for example, video camera, photo) in order to successfully complete the assignment.

In at least one embodiment, the system 100 may verify the duration of the video. The system 100 may automatically detect the duration of the video in the uploaded video file. For example, this may be done using metadata provided with the video. The video file may be automatically rejected if it is not within a permitted range of durations. For example, a permitted range of duration of the video may be between 1 and 6 seconds.

In at least one embodiment, the system 100 may verify the uniqueness of videos. The system 100 may verify whether each uploaded video is different from any other video submitted previously (in the same or in any other assignment). This may be done to prevent attempts to “game” the system by re-submitting multiple copies of a single video.

For example, a duplicate detection may be performed by creating and maintaining a hash-code database which would compute or extract, collect and store hash-codes for each accepted video in a hash-code database 126. For each newly submitted video, the system 100 may verify that its hash-code is not contained in the hash-code database 126. For example, the hash-codes of two almost the same (but not exactly) identical videos are with very high likelihood completely different from each other. If the video file hash-code is a duplicate of one of the hash-codes stored in the hash-code database, the submitted video may be rejected. For example, the upload box of this video will remain unchanged and the submit button of the batch will not release until all videos of the batch are uploaded and accepted. The provider may thus be forced to provide an acceptable (valid) video before being able to submit the batch.

The platform 120 may also support near-duplicate detection by storing not only hash-codes but also feature vectors extracted from the videos in the database. Feature vectors may be extracted by feeding the videos to a network trained on a video prediction task, and computing the representation in a hidden layer of the network. Near-duplicate detection may then be performed by comparing a feature vector extracted in the same way from the incoming video to the feature vectors stored in the database. In at least one embodiment, feature vectors may be binarized to improve the efficiency with which the similarity between feature vectors may be computed.

In at least one embodiment, if the uploaded video file is a near-duplicate of the one of the label-related video file stored in the memory, the video file may be rejected. For example, a near-duplicate may be a video that is very similar to an existing video. It may be impossible to use hash-codes to detect near-duplicates, because two almost identical videos generally have completely different hash-codes.

In at least one embodiment, the system 100 may verify the uniqueness of videos within one or several assignments. For example, the operators 108 may initiate near-duplicate detection to be performed for a single provider 104. Such detection of near-duplicates may be performed based on a Siamese network (a network architecture that can learn to compute the similarity between two input items) trained on near-duplicates. This may provide an extra level of quality control for a selected set of video providers 104, such as those that are supposed to be set to auto-approval but are not yet considered “safe”. Since such verification may be computationally expensive, this kind of near-duplicate detection may be provided for a small number of videos, such as those within one assignment.

In at least one embodiment, the system 100 may verify (check) whether the input text entered by the provider 104 in the input mask have been well-formed. For example, the system 100 may verify the input text by searching up in an electronic dictionary for nouns. The system 100 may also verify syntactic correctness for larger phrases in the label text.

For example, some video providers 104 may be pre-approved for fully automatic approval by the platform 120. The videos received from these pre-approved providers 104 (e.g. through specific accounts and/or from specific IP addresses and/or specific provider devices 105) may, for example, be subjected to a reduced number or automatic checks. For example, the videos received from the providers that were pre-approved may be marked as such by the system 100 to inform the operator that they come from the pre-approved provider. Such additional flagging of the pre-approved providers and/or their submitted videos may help the operator to take the decision of approval of the videos faster. For example, the videos received from the providers that were not pre-approved may be marked as such to inform the operator that further inspection may be needed. In at least one embodiment, all videos may go through the automated quality control checks, but submissions by those providers who were flagged “pre-approved” may not need detailed reviewing by the operators. For example, it may be at the discretion of the operator how much time (if any) they spend on reviewing a submitted video batch, and the pre-approved flag may assists the operators in making that decision, allowing them to immediately click the “approve”-button without closely inspecting each video in the submitted batch.

In addition to the automatic checks, the operator 108 may review any assignments of any video provider 104. Such review may be enabled by displaying, on the screen of the operator 108, of the data on the video uploaded as well as the label text of each uploaded video.

For example, the system 100 may record all videos that were uploaded, including those that have been rejected. Videos that were rejected may be saved (recorded) by the system 100 in a separate rejects database 124 which may store negative examples of videos. The videos stored in the rejects database 124 may later be used for training quality inspection models, allowing for a higher degree of automation in the future.

Collecting video based on label templates may make it possible to dynamically adapt the data collection operation itself in response to the capabilities of trained machine learning models.

The purpose of the system 100 is to collect video data for training machine learning models. An ongoing data collection campaign may require feedback from modelers and researchers about data quality, data issues and possible adjustments to an ongoing collection campaign that may improve prediction performance of the machine learning models.

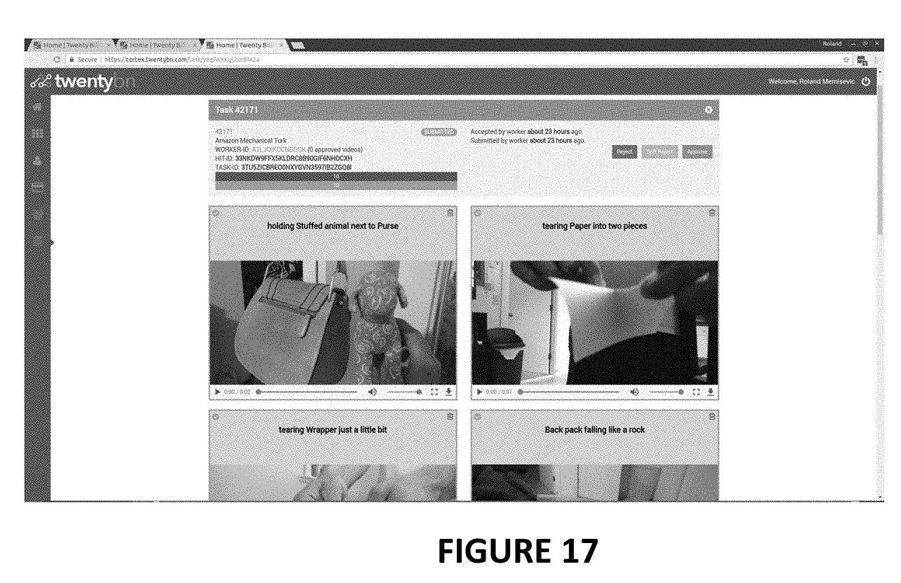

A collection summary may comprise a plurality of label texts and a plurality of label-related videos (see, for example, FIG. 17). The collection summary may be displayed on the operator's device 110. The videos may be played and displayed, for example, simultaneously.

The collection summary may correspond to one video batch submitted by a video provider.

In at least one embodiment, the system 100 may generate a data time-period snapshots. The data time-period snapshot may have data (all data or a portion of the data) gathered by the system 100 and/or platform 129 during a certain period of time (for example, the data created up to that day, or, for example, the data created during one particular day, e.g. current day). Such time-period snapshot may be downloaded by modelers involved in developing and training machine learning models, allowing them to communicate issues and suggestions to the operators.

The data time-period snapshot may be provided as a text-file containing labels as well as pointers to the corresponding video-files. For example, the system 100 may generate a time-period snapshot comprising one or more files with various subsets of data. For example, the time-period snapshot may have a subset of data for training (training-data subset), a subset of data for validation (validation data subset) and/or a subset of data for testing (test-data).

For example, the generation of training-data subset, validation data subset, or a test-data subset may be performed automatically. The system may distribute each video and/or data/information regarding each video (such as, for example, label template 24, label text, provider 104, hash-tag, and/or timing of upload, etc.) in one on these subsets.

The generation of training-data subset, validation data subset, or a test-data subset may be optimized, for example, by performing a random search to satisfy the various criteria. For example, such search may be performed automatically every day or within any other period of time. For example, the first criteria (i) may be such that, for each label, the set of videos collected and/or recorded corresponding to this label may be distributed between training-data subset, validation data subset, or a test-data subset, such that it approximately satisfies pre-defined percentages (for example: 80% for train data, 10% for validation-data, and 10% for test-data). (ii) As a second criteria, for each label, each of training-data subset, validation data subset, and a test-data subset may preferably contain as many different video providers 104 as possible (i.e. to provide “provider-heterogeneity”). (iii) The third criteria may be that all videos submitted at any time by any given video provider 104 may be assigned to only a single subset (train-data subset, validation-data subset or test-data subset). It should be understood that these criteria may be applied all at the same time, or separately to various time-period snapshots, or in specific sequence.

For example, the third criteria (iii) as described above may help to assure that any potential statistical properties shared between the videos of any one video provider 104 do not yield systematic errors in the evaluation of the performance of the trained models.

The generation of the train-data subset, validation-data subset and test-data subset may be performed by randomly sampling splits satisfying the third criteria (iii) so as to minimize a cost-function that quantifies points (i) and (ii). The cost-function corresponding to (i) may be the squared distance between the desired percentages and the percentages induced by a particular split. The cost-function corresponding to (ii) may be the sum of squared distances between the three-dimensional vectors representing even distributions of workers (for any given label) across train-, validation-, and test-set, and the three-dimensional vectors representing the distributions induced by a particular split.

In at least one embodiment, the system 100 may record (keep track of) labels provided by each video provider 120. In order to generate data with sufficient variability, the system 100 may make sure that each label text is represented by videos from as many different video providers 104 as possible. Therefore, the system 100 may register and store (keep track) the labels recorded by each individual video provider 104, as well as of provided input text (placeholder-entries).

The system 100 may also generate for each video provider 104 a list of labels to choose from. For example, the system 100 may dynamically generate such list of labels for each video provider taking into account the recorded and stored information on the set of labels recorded by each individual video provider 104.

Keeping track of the labels provided by each provider 104 furthermore may make it possible to generate and send an alert to operators 108 when the number of videos submitted for a label exceeds a label threshold (Lₘₐₓ) or when the number of input texts (placeholder-entries) submitted exceeds an input text threshold (placeholder-entries threshold) (Pₘₐₓ). This may allow operators to focus on, or selectively investigate, the submissions by video providers with large numbers of submissions for a single label and/or input text, and to verify that the uploaded videos show sufficient variability.

In at least one embodiment, the system 100 may prompt for and record a feedback on completed or partially completed submissions. When fully or partially rejecting a submission, the operators 108 may provide feedback to the video provider 104 to clarify what was wrong with the submission. The system 100 may provide a feedback text input field for this purpose.

For example, the text input field for approvals may be prefilled with the pre-defined text, such as, for example: “Well done!”. The text input field for rejections may be pre-filled with the pre-defined text, such as, for example: “Sorry, but the videos that you uploaded don't quite meet the requirements. Please read the instructions more carefully.”. Both text input fields may be editable so that operators 108 may overwrite or modify these before sending the message, along with the approval or rejection information, to the video provider 104.

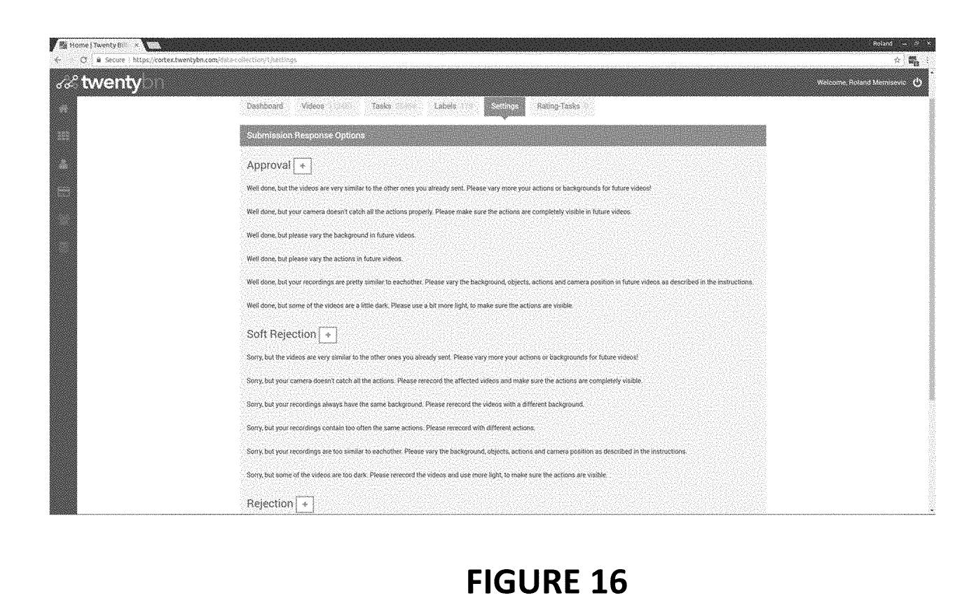

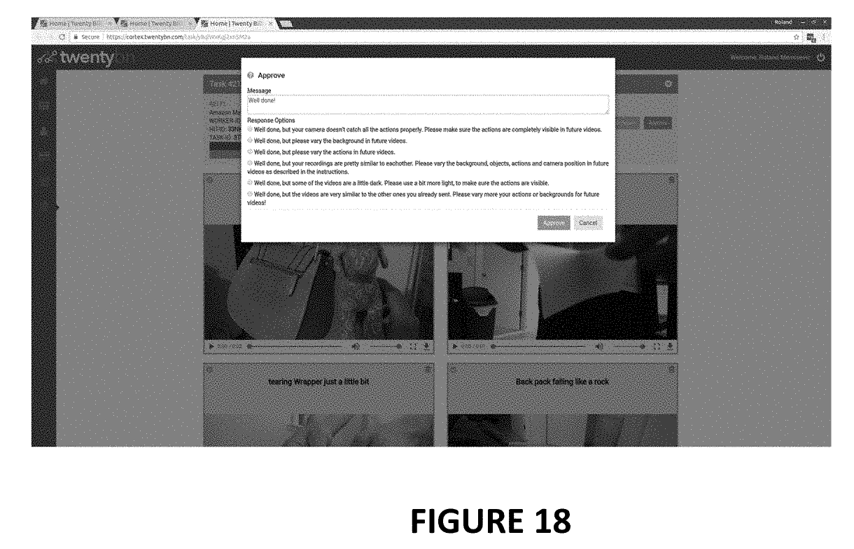

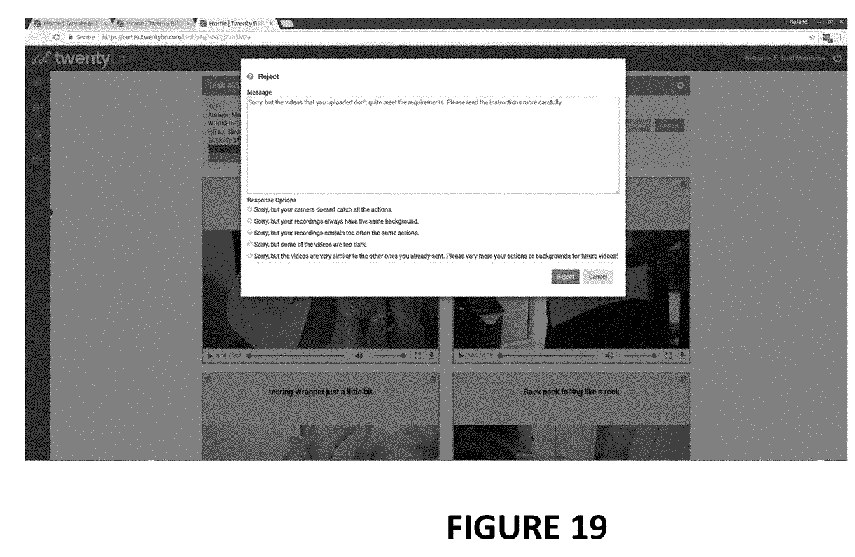

Referring now to FIGS. 16, 18, 19, and 20, the platform may also provide a selection of messages with which the operator can fill the text-input-field (FIGS. 18,19, 20) upon a click of a button. Operators may be allowed to edit, add or remove messages in the selection.

For reviewing submissions, the platform may display a “mosaique” of multiple videos from a task. These videos may be played back simultaneously and in a continuous loop. This may allow operators to view many labels at a glance, and to quickly spot those videos that may need to be rejected and that need closer inspection. To allow the simultaneous playbacks of multiple videos to stay synchronous, the platform may sort the videos by length and confine the mosaique to sets of videos whose lengths are either approximately the same, or to sets in which the length of any video is approximately an integer-multiple of the length of all other videos.

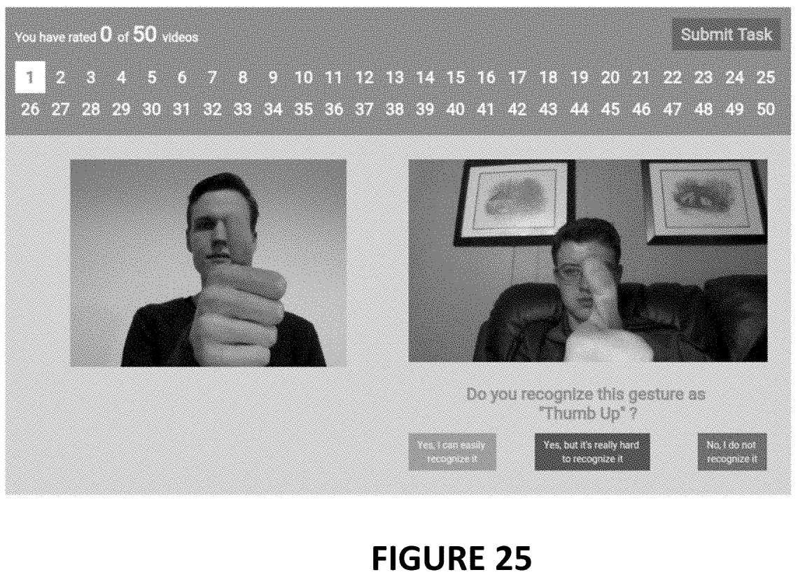

As mentioned above, operators may be company personnel or crowd-workers. Unlike company personnel, crowd-workers may not be as skilled or as incentified as company personnel to correctly judge the quality of submissions. To address this issue, the platform 120 may support the labeling or reviewing of videos by crowd-workers by providing video labeling-tasks (an example is shown at FIG. 25). Like the video-collection tasks, the video labeling tasks may be distributed via crowdsourcing services such as Amazon Mechanical Turk or Clickworker.

For example, the crowd-workers may be prompted to rank the quality of a batch of videos and their associated labels.

The set of quality rankings collected for a video may be used to decide if the video should be kept or removed from the database. For example, the video may be removed if the average ranking it received is below a threshold.

The set of quality rankings may also be used to weight the impact of the video during training, for example, by multiplying the learning update for this video (typically the derivative of some cost function) by a weighting function derived from the rankings. A simple weighting function is the average ranking.

The average standard deviation of the rankings of a crowd-worker may be used to determine the reliability of the crowd-worker. A crowd-worker whose rankings persistently or systematically differ from rankings assigned by other crowd-workers for the same videos may be excluded from the ranking tasks.

In at least one embodiment, the system 100 may be crowdsourcing marketplace-agnostic. The platform can interact with providers 104 from multiple different crowdsourcing marketplaces as well as with company personnel or contract workers. The latter may make it possible to add videos that are acted or generated by domain experts and videos that may require more specific instructions or even specialized training.

To reduce cost and to maximize inflow, the system 100 may be designed to provide a convenient, easy-to-use and responsive interface to the video providers, which is not provided by existing crowdsourcing market places. Crowdsourcing the generation of videos may be costly. For example, the recording of 30-second videos at a non-zero inflow-rate may cost at least 3$ USD per video (that is, 10 cents per second) in the absence of worker recruitment or retention tricks based on bonus payments. In contrast, with the platform 120 and system 100 described herein, peak-inflow rates of up to 2000 videos in a single day (albeit for shorter videos of up to 6 seconds duration) at 10 cents per video (that is, 1.7 cent per second) have been achieved, and lower inflow rates of hundreds of videos per day at even lower cost per video.

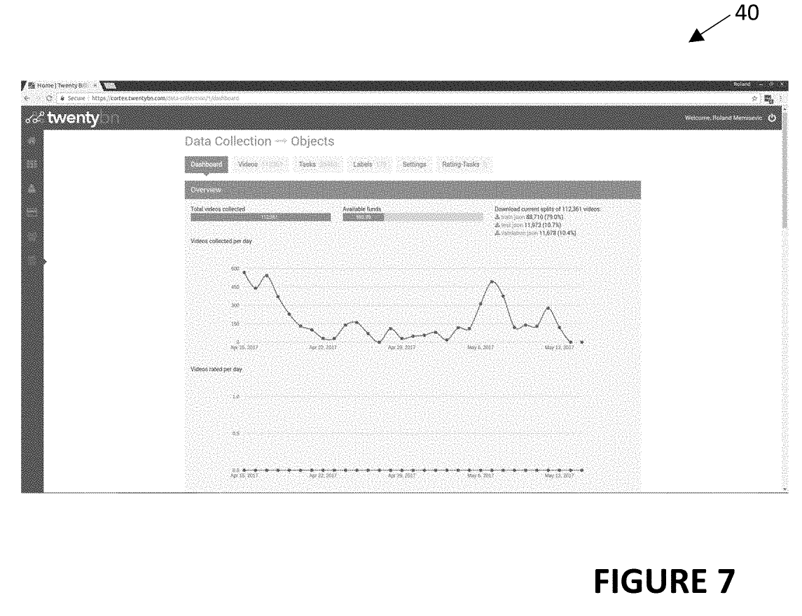

Referring now to FIG. 7, shown therein is an example of a dashboard 40 which is displayed by the system 100 on the operator device 110. The operator 108 may interact with the system 100 using this dashboard 40. For example, the system 100 may display on the dashboard 40 a summary information about the ongoing video collection campaign.

For example, the number of assignments that are currently pending may be displayed on the dashboard 40. For example, the system 100 may extract and display the number of assignments selected and submitted by one or more video providers 104, but not yet reviewed in a certain period of time. The system 100 may also extract and display the number of assignments that have been accepted, as well as the number of assignments that have been rejected or soft-rejected in a certain period of time. For example, this information may be displayed with a daily resolution reaching back, for example, a certain number of days (e.g. 30 days) into the past. This may allow the operator 108 to observe, and potentially act on, any potential trends or issues (such as, for example, a decline in selections or an increase in rejections, etc.).

The dashboard 40 may further provide information about remaining funds, if applicable (for example, when utilizing a paid-for crowdservice) and the total number of videos collected so far. It may also provide download-buttons that may make it possible to download the data for training machine learning models.

For example, the system 100 may use (for example, by sending a request to the Amazon server) the Amazon MTurk in order to obtain from the Amazon MTurk a pool of providers. Once a provider has signed up, the provider may receive a link to the platform of the system 100 where all the communication with the system is performed. Upon completion of their work, the system 100 may signal to Amazon (e.g. using Amazon's API), that the task has been completed and the provider should be paid.

The role of MTurk and other crowdsourcing services may thus be limited to provide a coarse task description to the workers, and if workers sign on, they get forwarded to the platform 120 where the method as described herein is performed. Only the approval and payment information may further be sent back to the crowdsourcing service.

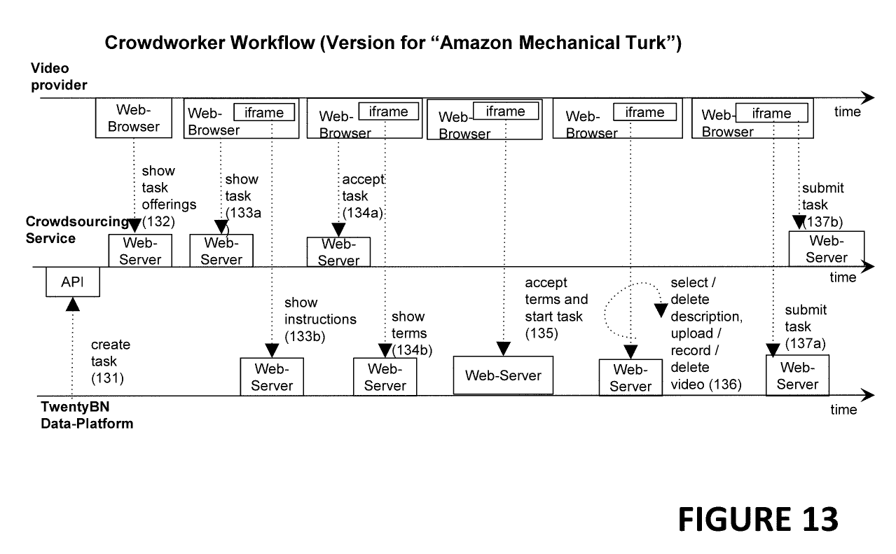

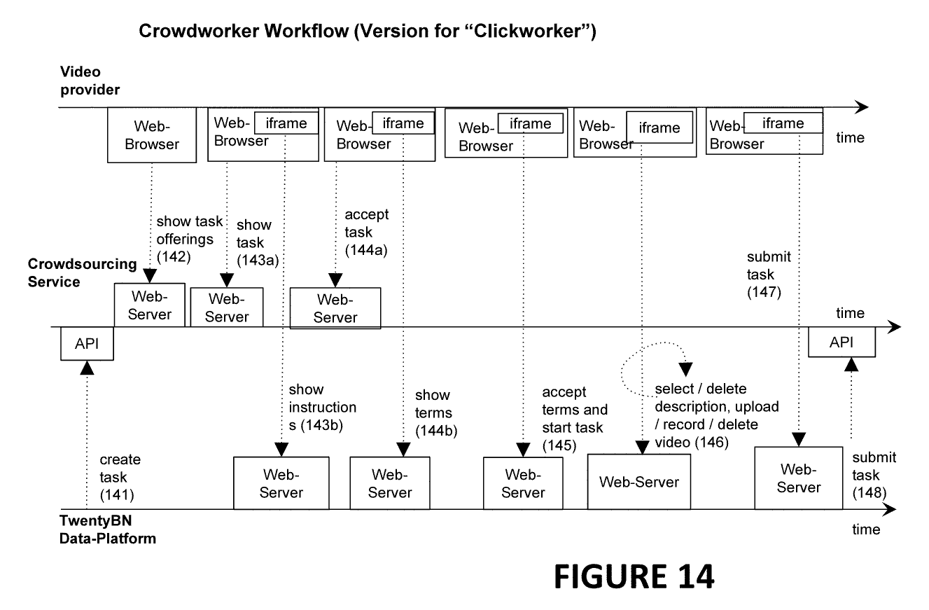

Referring to FIGS. 13-15 shown therein are examples of workflow for different crowdsourcing services, such as Amazon Mechanical Turk (FIG. 13) and Clickworker (FIG. 14), when the information and data is exchanged between the exemplary platform 120 as described herein (referred to in Figures as “TwentyBN”) with the provider. At FIG. 13, at step 131, a background process running in the system 100 is creating a new task using the crowdsourcing service's API. At step 132, the video provider may search for suitable task offerings on the crowdsourcing service's website. At step 133a, the video provider may show one of platform 120 tasks. For this, at step 133b, the crowdsourcing provider's website may embeds an Iframe which may load the instructions page for the task from the platform 120 web server. At step 134a the video provider may accept the tasks. For this, at step 134b, the crowdsourcing provider's website may embed another iframe, which may load the terms from the platform 120 web server. At step 135, the video provider may accept the terms and start the task by sending a request to the platform's 120 web server. The user may be redirected to the task page. At step 136, the video provider may carry out the task by repeatedly selecting or deleting descriptions and uploading, recording or deleting videos on the platform's 120 web server. At step 137, the video provider has finished a task. For this, an asynchronous request may be sent at step 137a to the platform's 120 web server. Then, at step 137b, a synchronous request to the crowdsourcing service's web server may be sent.

Referring now to FIG. 14, at step 141, a background process running in the platform 120 may create a new task using the crowdsourcing service's API. At step 142, the video provider may search for suitable task offerings on the crowdsourcing service's website. At step 143a, the video provider may show one of platform's 120 tasks. For this, at step 143b the crowdsourcing provider's website may embed an Iframe which may loads the instructions page for the task from the platform's 120 web server. At step 144a, the video provider may accepts the tasks. For this, at step 144b, the crowdsourcing provider's website may embed another iframe, which may load the terms from the platform's 120 web server. At step 145, the video provider may accept the terms and start the task by sending a request to the platform's 120 web server. The user may be redirected to the task page. At step 146, the video provider may carry out the task by repeatedly selecting or deleting descriptions and uploading, recording or deleting videos on the platform's 120 web server. At step 147 the video provider may have finished the task. For this, a request may be sent to the platform's 120 web server. Finally, at step 148, the platform 120 may send a request to the crowdsourcing service's API to submit the task.

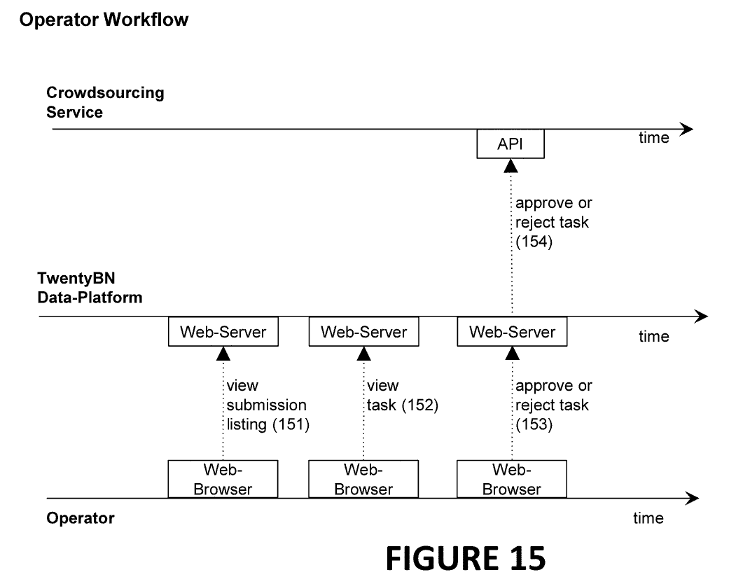

FIG. 15 shows an example of a workflow for an operator that may be used when the operator communicates with any crowdsourcing service. At step 151, the operator may use a web browser to view the submission listing served by the platform's 120 web server. At step 152, the operator may use a web browser to view a submitted task served by the platform's 120 web server. At step 153, the operator may decide if the task should be approved or rejected and may sends a request to the platform's 120 web server. At step 154, the platform 120 may send a corresponding, i.e. approve or reject request to the crowdsourcing service's API.

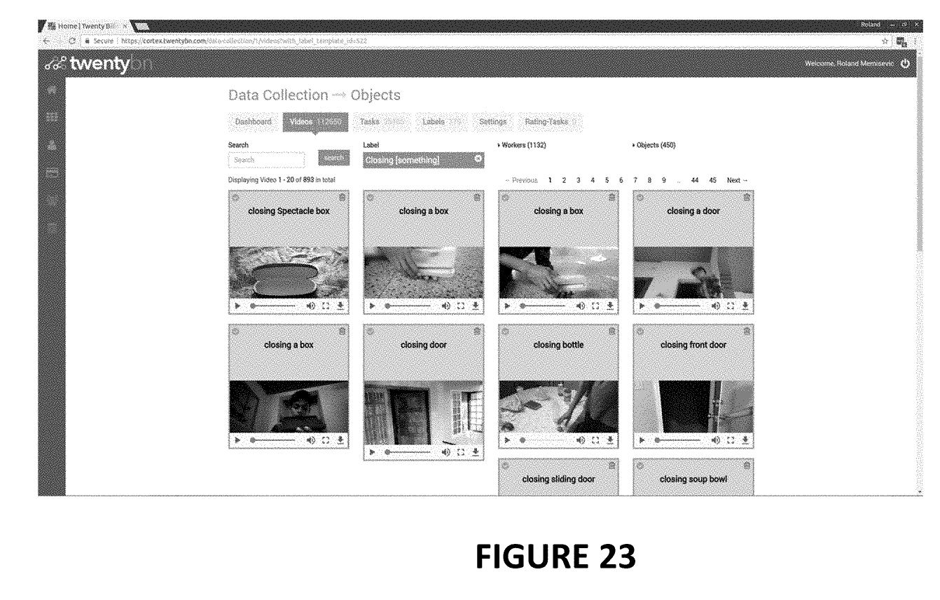

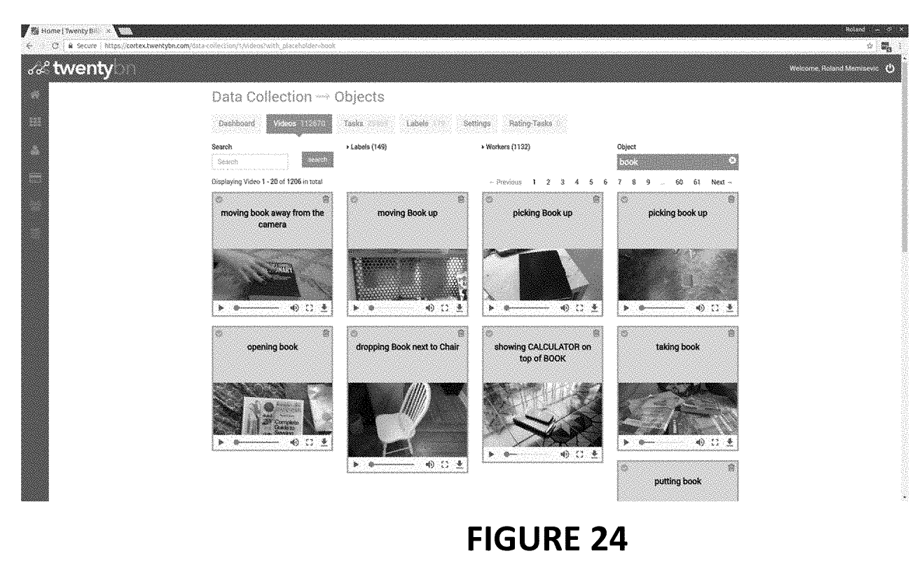

The dashboard 40 may further display links to pages which may summarise the information on particular subjects. For example, the dashboard 40 may display a link to a video page which may make it possible to search through the submitted videos by label (FIG. 23), input text (FIG. 24) or video provider. It may serve to inspect the quality of videos collected so far and to react to potential issues that may become clear during the ongoing campaign. For example, if a certain label is consistently misunderstood, or the corresponding videos lack the variability required for a machine learning model to generalize, the operator may change the wording of the label or the instructions to try to alleviate the problem.

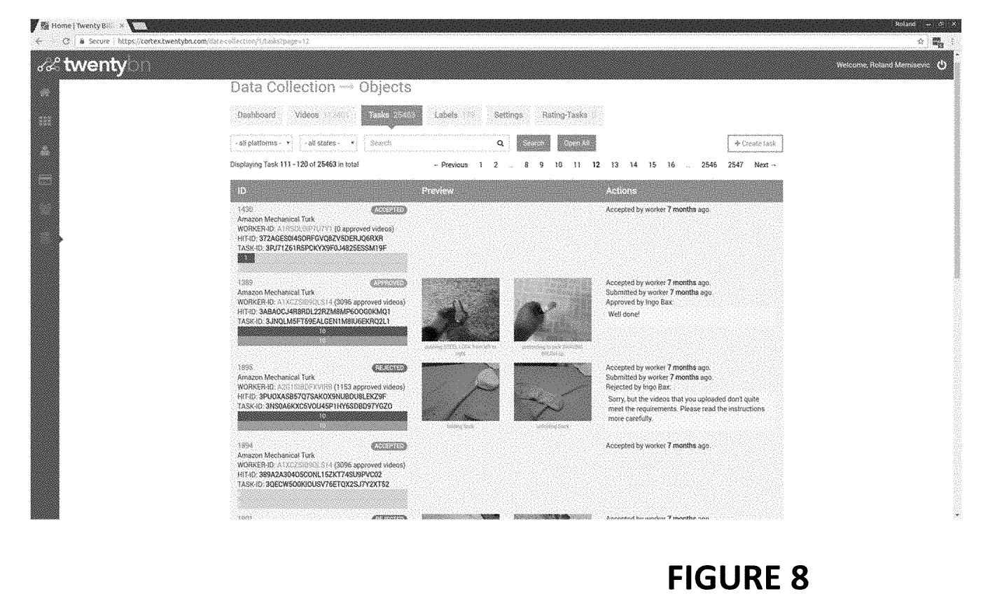

Referring now to FIG. 8, the assignment overview page 41 may display one or more links to one or more assignments pages. For example, the system 100 display one or more sets of assignments (displayed, for example, on multiple sub-pages). It may be primarily used by the operator 108 to go through the list of pending assignments and to approve (accept) or reject these. Operators 108 may inspect an assignment upon clicking on the assignment ID shown in this view.

Still referring to FIG. 8, a subset of videos may be played automatically, and a “quick-approve” button may be shown next to the videos. Often a small subset of labels (such as the labels that are the most difficult for providers to film) can reveal with high likelihood that a given submission is OK to be approved or not. The “quick-approve”-button may allow the operator to quickly approve or reject the submitted batch without having to inspect all videos or having to descend into the submission-page.

The inspection of videos may be based on an interface similar to the interface seen by the video providers. It may allow operators to watch submitted videos, provide feedback and potentially remove individual videos or whole assignments that do not satisfy the requirements. The removal of individual videos may not, for example, result in rejection of a complete assignment, as complete rejections can negatively affect the crowdworker's ranking on crowdsourcing services like AMT, and reduce inflow and thereby increase cost.

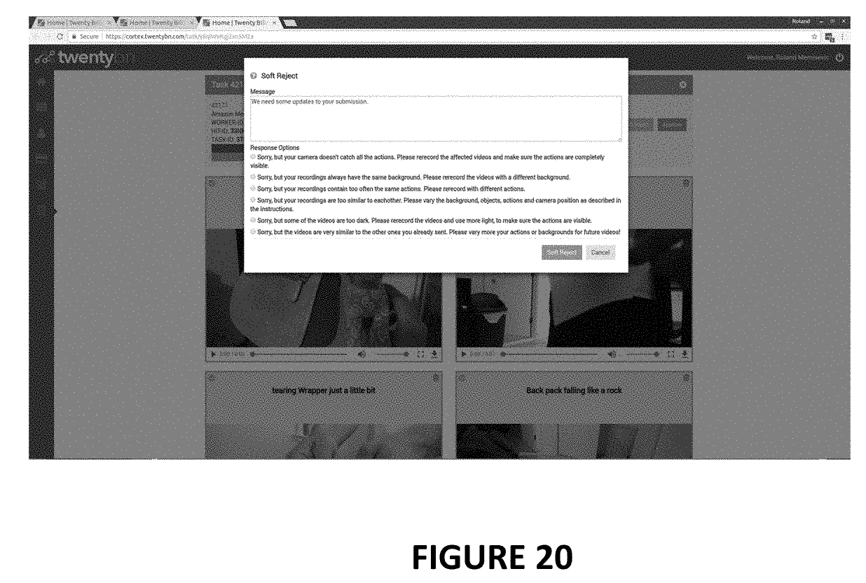

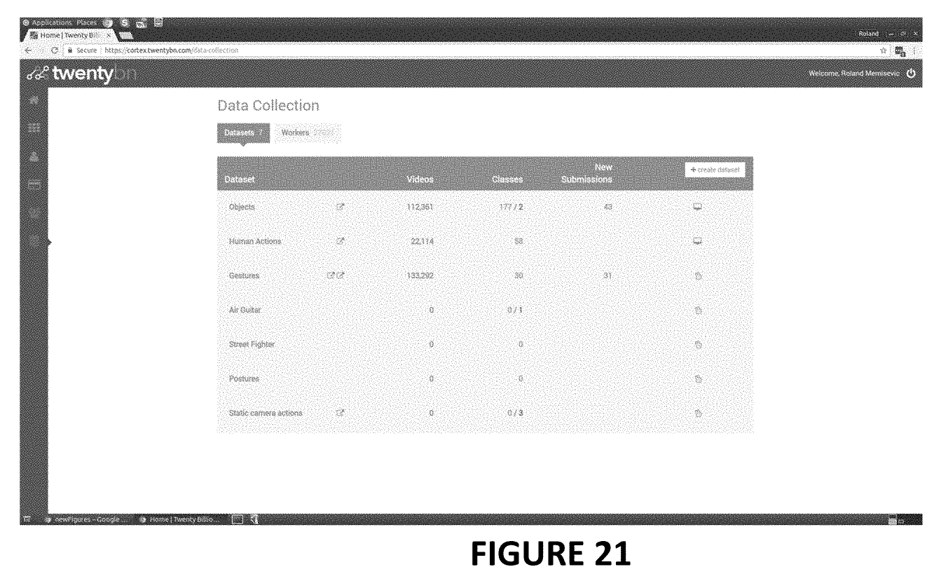

In at least one embodiment, the rejection of submissions may be immediately communicated to the crowdsourcing service. Since rejections may negatively affect a video provider's ranking in that service, the platform may allow operators to “soft reject’” a submission (see FIG. 17, FIG. 20). For example, the “soft rejection” may be identical to a rejection, except that the video provider may be granted a grace period (for example, 48 hours) in which he/she may correct any issues detected and communicated by the operator. An automatic time-out may be used to reject a submission that has not been corrected by the video provider. As some crowdsourcing services (for example AMT) may automatically approve pending assignments after a fixed amount of time, the duration of the grace period may be set to a value that is smaller than the time until the automatic approval would take place.

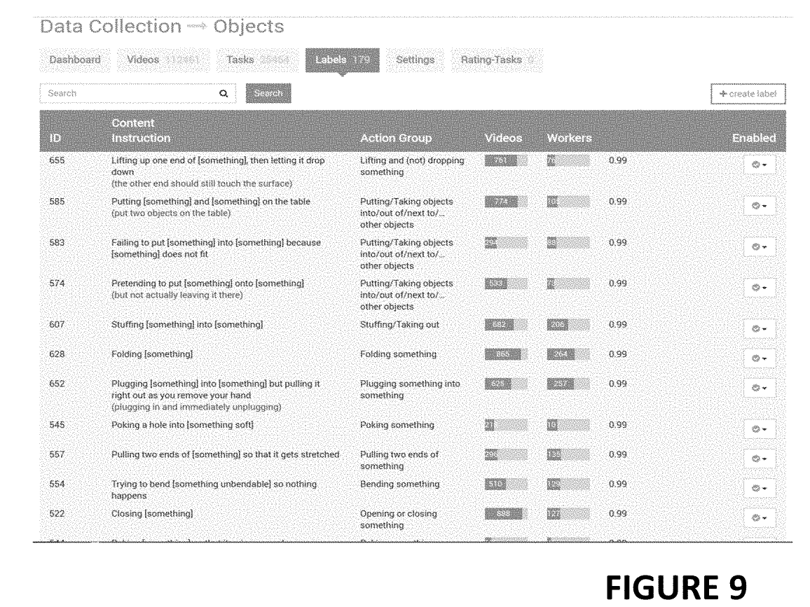

Referring now to FIG. 9, shown therein is an exemplary screenshot with a list-view of all labels and the corresponding number of videos collected so far for each label. It may also show, for each label, the number of video providers 104 who uploaded videos for this label. This number may be an indication of the heterogeneity of the data associated with the label, as videos uploaded by the same video provider may have the tendency to show systematic similarities.

Such similarities may be caused by multiple different factors, including similar weather, similar background, similar objects, and similar motion patterns entrenched (usually unconsciously) in the video provider's motor-routines or -habits. Systematic similarities may reduce the capability of a machine learning model to generalize. This functionality may allow operators to control and minimize this problem. Videos provided by distinct providers may have much less systematic similarities.

Upon deciding that similarities have to be reduced, operators may limit the number of videos for a given label and/or placeholder values that any given video provider may be allowed to submit.

The Labels-page as shown at FIG. 9, may further allow operators 108 to control the number of videos that are generated per label by turning a given label “on” or “off”. A label that is turned “off” may no longer appear in the list of labels shown to video providers 104. This may allow operators 108 to balance the dataset or to generate disproportionately more data for classes that appear to be more difficult to learn by the machine learning model than others.

The Labels-page may allow operators to add, edit or remove labels (and/or the explanatory text associated with the label). Allowing operators to add, edit or remove labels may allow them to react to potential problems that become apparent during the ongoing data collection process. For example, it may become apparent that the meaning of certain labels or their descriptions is insufficiently clear to some providers, or it may become apparent that models trained on the data may be able to improve accuracy by adding, aggregating or modifying certain labels or videos.

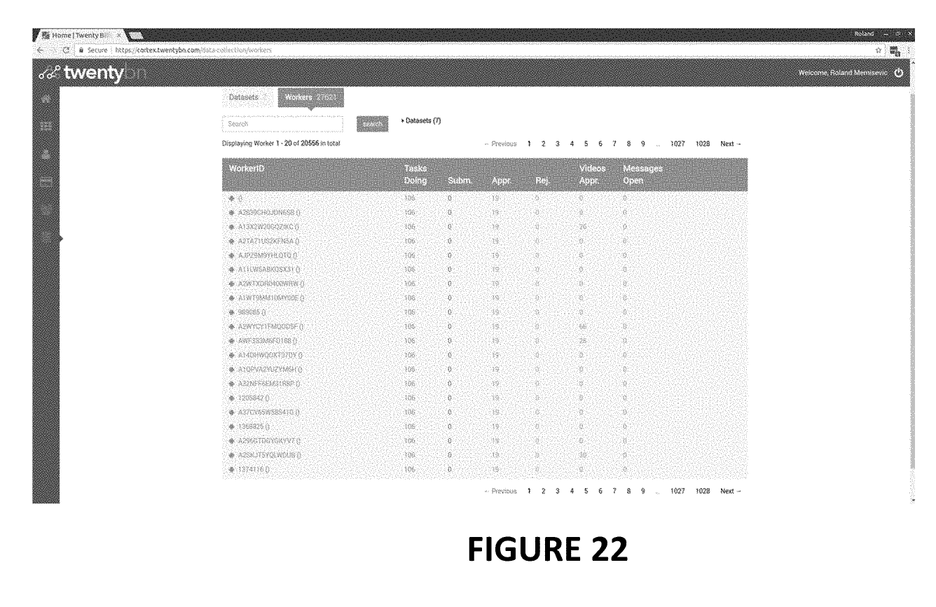

Referring now to FIG. 22, shown therein is a screenshot of an example operator interface with a list of video providers 104. This page may show a list of video providers 104. For example, this list may be searchable. Upon clicking on a video provider ID, the operator 108 may inspect, and search through, all videos submitted by this video provider 104. This may make it possible to inspect, detect or investigate potential issues or concerns regarding a video provider 104, and it may serve as a basis for communicating with the video provider 104. For example, the operator 108 may take a decision to block the video provider 104 from further submissions. Commonly encountered issues may include submissions of videos that are too similar to one another or of low quality (for example, not clearly reflective of the labels they are supposed to represent).

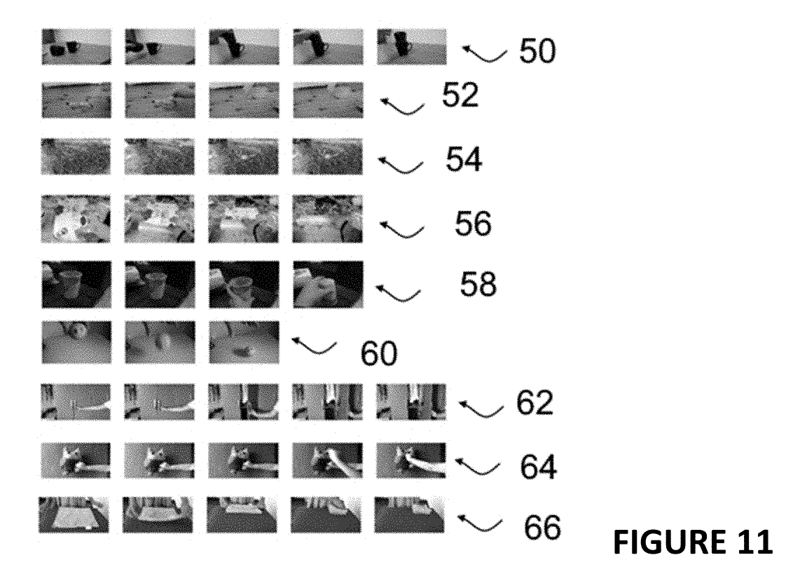

FIG. 11 shows examples of screenshots of videos for different labels. For example, the collected and stored videos may show putting a cup into a cup 50, taking a banana peel from the floor 52, throwing a pink toy-spoon onto a pile of brush 54, rolling up a placemat 56, turning a paper cup upside down 58, dropping a rubber ball onto the table 60, opening a wardrobe 62, punching a toy owl 64 and folding a pink towel 66.

The platform may be used to collect training data for building systems that detect that a person fell down (for example, as used in elderly care applications).

The platform may be used to collect training data for building systems that provide personal exercise-coaching by observing the quality of, or counting, physical exercises, such as push-ups, sit-ups, “crunches”.

The platform may be used to collect training data for building systems that provide meditation-, yoga-, or concentration-coaching by observing the pose, posture and/or motion patterns of a person.

The platform may be used to collect training data for building gesture recognition systems using RGB cameras.

The platform may be used to collect training data for building controllers for video games, so that these games may be played without the need of holding, or keeping otherwise close to the body, any physical device. Examples include, driving-games, fighting games, dancing games.

The platform may be used to collect training data for building interfaces to music or sound generation programs or systems, for example, an “air guitar” system that generates sounds in response to, and as a function, of imaginary guitar-, drum-, or other musical instrument-play.

The platform may be used to collect training data for building a posture-monitoring system, i.e. a system that observes and ranks a user's posture and possibly notifies the user of bad posture.

The platform may be used to collect training data for building systems that recognizes gaze-direction or changes in gaze-direction, as used, for example, in cars to determine if “auto-pilot”-functions are to be engaged or not.

The platform may be used to collect training data for building systems that may recognize that an object was left behind, as used in video surveillance applications of public spaces.

The platform may be used to collect training data for building systems that recognize that an object was carried away, as used, for example, in domestic surveillance applications.

The platform may be used to collect free video captions by asking video providers to film anything and provide both the video and a description of what is shown in the video.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1) A system for video data collection from a video provider device, the system comprising:
a memory for storing video files; and
a processor operable to communicate electronically with the memory and the video provider device, the processor operating to:
display a plurality of label templates on the video provider device;
for each label template selected by the video provider:
transfer a label-related video file from the provider device to the processor;
record the label-related video file in the memory;
record a label text, the label comprising at least a portion of the label template, in the memory; and
associate the label-related video file with the label text.

2) The system of claim 1, wherein each label template comprises at least one placeholder, and for each label template, selected by the video provider, the processor is operable to:
receive a text entry provided by the video provider at the video provider device; and
generate the label text based on the label template by replacing the placeholder with the at least one text entry.

3) The system of claim 1 wherein each of the plurality of the label templates comprises at least one action term.

4) The system of claim 1, wherein the label text is the label template.

5) The system of claim 1, the memory further comprising a video database operable to store label-related video files and associated label text.

6) The system of claim 2 wherein the at least one text entry represents an object the action has been applied to.

7) The system of claim 1 wherein the processor is operable to:
display a plurality of action groups on the video provider device, each action group having the plurality of label templates; and,
for each action group selected by the video provider, the processor is operable to display the at least one label template.

8) The system of claim 7, wherein the processor is configured to dynamically select the at least one action group to be displayed from an action group database.

9) The system of claim 1, wherein the processor is configured to dynamically select the at least one label template to be displayed from a label templates database.

10) The system of claim 9, wherein the selecting dynamically is based on collected data related to performance of machine learning models.

11) The system of claim 1, wherein the processor further operates to, upon selection of each label template by provider, displaying, on the video provider device, a video upload box for that label template for uploading a video file.

12) The system of claim 11, wherein the video upload box allows the provider to play back the label-related video.

13) The system of claim 12 wherein the video upload box allows multiple re-uploading of the video.

14) The system of claim 1 further comprising an operator device, the processor being further operable to communicate with the operator device.

15) The system of claim 14, the processor being further operable to generate and to display, at the operator device, a collection summary comprising a plurality of label texts and a plurality of label-related videos.

16) The system of claim 15, wherein the collection summary comprises multiple videos being played and displayed simultaneously on the operator device.

17) The system of claim 14, wherein the operator device is operable to prompt the operator to approve or reject a set of the videos and then to transmit the approval or rejection to the video provider device and to the platform.

18) The system of claim 14, wherein the system is operable to display a feedback text input field at the operator's device, collect the feedback text, transmit the feedback text to the video provider device and display the feedback at the video provider device.

19) The system of claim 14, the processor being further operable to:
receive a duration of a grace period for a resubmission of at least one label-related video and a soft-reject message from the operator device,
transmit the duration of the grace period and the soft-reject message to the video provider, and,
after expiration of the grace period, reject the at least one label-related video.

20) The system of claim 1, wherein the memory comprises a hash-code database, the processor being operable to collect, for each label-related video file, the file hash-code and record the collected hash-code in the hash-code database.

21) The system of claim 1 further comprising prompting the video provider to select a batch-size number of label templates to form an assignment.

22) The system of claim 21, wherein the processor is operable to accept an assignment only after all label-related video files of one batch have been uploaded, the batch having the batch-size number of label-related video files, each corresponding to the pre-defined batch-size number of label templates.

23) The system of claim 1 wherein the processor is further operable to evaluate quality of the label-related video file.

24) The system of claim 1, wherein the memory comprises a rejects database, the processor being operable to record the collected label-related video file in the rejects database.

25) The system of claim 1, wherein the processor is operable:
to extract a format of the label-related video file;
to compare the format of the label-related video file with a permitted format; and
if the format of the label-related video file is not in a permitted format, record the label-related video into the rejects database.

26) The system of claim 25, wherein the format of the label-related video file is at least one of file encoding, file extension, video duration.

27) The system of claim 1, wherein the processor is operable:
to extract a format of the label-related video file during uploading of the label-related video-file;
to compare the format of the label-related video file with a permitted format during uploading of the label-related video-file; and
if the format of the label-related video file is not in the permitted format, send an alert to the video provider device to alert the video provider that the format is not in the permitted format.

28) The system of claim 20, wherein the processor is operable:
to collect a hash code of the label-related video-file while uploading the label-related video-file and, if the video file hash-code is a duplicate of one of the hash-codes stored in the hash-code database, send an alert to the video provider device to alert the video provider that the label-related video-file is a duplicate.

29) The system of claim 20, wherein the processor operates to:
for each newly transferred label-related video file, invoke near-duplicate detection; and
if the label-related video file is a near-duplicate of the one of the label-related video file stored in the memory, reject the label-related video file or communicate to the operator device that the uploading of a near-duplicate has been detected.

30) The system of claim 1, wherein the processor operates to analyse data collected in the memory and to generate at least one data subset, the data subset being at least one of training-data subset, validation data subset, or a test-data subset.

31) Using the system of claim 1 for curriculum learning of machine learning models.

32) The system of claim 1, wherein the processor is further operable to, for each label template selected by the video provider:
communicate with a video camera to initiate recording;
display, on the video provider device, the video being recorded by the video camera and transferring the recorded label-related video file from the provider device to the platform; and
communicate with the video camera to stop recording.

33) The system of claim 32, wherein the processor is further operable to record the video and transfer the recorded label-related video file from the provider device to the platform is done simultaneously.

34) A method for video data collection from a video provider device by a platform, the method comprising:
displaying a plurality of label templates on the video provider device;
for each label template selected by the video provider:
transferring a label-related video file from the provider device to the platform;
recording the label-related video file;
recording a label text, the label comprising at least a portion of the label template;
associating the label-related video file with the label text.

35) The method of claim 34, wherein each label template comprises at least one placeholder, and for each label template, selected by the video provider:
receiving a text entry provided by the video provider at the video provider device; and
generating the label text based on the label template by replacing the placeholder with the at least one text entry.

36) The method of claim 34 wherein each of the plurality of the label templates comprises at least one action term.

37) The method of claim 34 wherein the label text is the label template.

38) The method of claim 35 wherein the at least one text entry represents an object the action has been applied to.

39) The method of claim 34 wherein the at least one object text represents an object the action has been applied to.

40) The method of claim 34 further comprising:
displaying a plurality of action groups on the video provider device, each action group having the plurality of label templates; and,
for each action group selected by the video provider, displaying the at least one label template.

41) The method of claim 34, further comprising dynamically selecting the at least one action group to be displayed from an action group database.

42) The method of claim 34, further comprising dynamically selecting the at least one label templates to be displayed from a label templates database.

43) The method of claim 43, wherein the selecting dynamically is based on a collected data related to performance of machine learning models.

44) The method of claim 34, further comprising, upon selection of each label template by provider, displaying, on the video provider device, a video upload box for that label template for uploading a video file.

45) The method of claim 34 further comprising generating and displaying, at an operator device, a collection summary comprising a plurality of label texts and a plurality of label-related videos.

46) The method of claim 34, wherein the collection summary comprises multiple videos being played and displayed simultaneously on the operator device.

47) The method of claim 45, further comprising prompting the operator to approve or reject a set of the videos and then transmitting the approval or rejection to the video provider device and to the platform.

48) The method of claim 45, further comprising displaying a feedback text input field at the operator's device, collecting the feedback text, transmitting the feedback text to the video provider device and displaying the feedback at the video provider device.

49) The method of claim 45, further comprising:
receiving a duration of a grace period for a resubmission of the label-related video and a soft-reject message from the operator device,
transmitting the duration of the grace period and the soft-reject message to the video provider, and,
after expiration of the grace period, rejecting the label-related video.

50) The method of claim 34, further comprising collecting, for each label-related video file, the file hash-code and recording the collected hash-code in a hash-code database.

51) The method of claim 50, further comprising:
for each newly transferred label-related video file, extracting a video file hash-code and comparing the video file hash-code with the hash-codes stored in the hash-code database; and
if the video file hash-code is a duplicate of one of the hash-codes stored in the hash-code database, rejecting the label-related video file.

52) The method of claim 50, further comprising:
for each newly transferred label-related video file, invoking near-duplicate detection; and
if the label-related video file is a near-duplicate of the one of the label-related video file stored in the memory, rejecting the label-related video file or communicating to the operator device that the uploading of a near-duplicate has been detected.

53) The method of claim 34 further comprising prompting the video provider to select a pre-defined batch number of label templates.

54) The method of claim 34, further comprising accepting an assignment only after all label-related video files of one batch have been uploaded, the batch having a pre-defined batch number of label-related video files, each corresponding to the pre-defined batch number of label templates.

55) The method of claim 44, wherein the video upload box allows the provider to play back the label-related video.

56) The system of claim 54 wherein the video upload box allows multiple re-uploading of the video.

57) The method of claim 34, further comprising evaluating quality of the label-related video file.

58) The method of claim 34, further comprising recording the collected label-related video files in a rejects database.

59) The method of claim 34, further comprising
extracting a format of the label-related video file;
comparing the format of the label-related video file with the pre-defined system format; and
if the format of the label-related video file is not in a pre-defined system format, recording the label-related video into the rejects database.

60) The method of claim 59, wherein the format of the label-related video file is at least one of file encoding, file extension, video duration.

61) The method of claim 34, further comprising:
extracting a format of the label-related video file during uploading of the label-related video-file;
comparing the format of the label-related video file with a pre-defined system format during uploading of the label-related video-file; and
if the format of the label-related video file is not in the pre-defined system format, sending an alert to the video provider device to alert the video provider that the format is not in the pre-defined system format.

62) The method of claim 49, further comprising:
collecting a hash code of the label-related video-file while uploading the label-related video-file and, if the video file hash-code is a duplicate of one of the hash-codes stored in the hash-code database, sending an alert to the video provider device to alert the video provider that the label-related video-file is a duplicate.

63) The method of claim 34, further comprising analysing data collected in the memory and generating at least one data subset, the data subset being at least one of training-data subset, validation data subset, or a test-data subset.

64) Using the method of claim 34 for curriculum learning of machine learning models.

65) The method of claim 34, further comprising, for each label template selected by the video provider:
communicating with a video camera to initiate recording;
displaying, on the video provider device, the video being recorded by the video camera and transferring the recorded label-related video file from the provider device to the platform; and
communicating with the video camera to stop recording.

66) The method of claim 65, wherein recording the video and transferring the recorded label-related video file from the provider device to the platform is done simultaneously.

67) The method of claim 34, wherein an example video demonstrating the action to be performed is displayed near the video upload box.
